(19) United States
(12) Patent Application Publication
(10) Pub. No.: US 2024/0395154 A1
(43) Pub. Date: Nov. 28, 2024

(54) COLLISION AVOIDANCE FOR MANNED VERTICAL TAKE-OFF AND LANDING AERIAL VEHICLES

(71) Applicant: ALAUDA AERONAUTICS PTY LTD, Beverley (AU)

(72) Inventors: Matthew James PEARSON, Beverley (AU); Florian BREUT, Beverley (AU)

(73) Assignee: ALAUDA AERONAUTICS PTY LTD, Beverley (AU)

(21) Appl. No.: 18/259,215

(22) PCT Filed: Dec. 21, 2021
(86) PCT No.: PCT/AU2021/051533

§ 371 Date: Nov. 13, 2023

(30) Foreign Application Priority Data
Dec. 24, 2020 (AU) 2020904851

(51) Int. Cl. G08G 5/04; B64C 29/00; B64D 45/00; G01C 21/16

(52) U.S. Cl. CPC G08G 5/045; B64C 29/0008; B64D 45/00; G01C 21/1652; G01C 21/1654; G01C 21/1656

(57) ABSTRACT

A manned vertical take-off and landing (VTOL) aerial vehicle comprises: a body comprising a cockpit having pilot-operable controls; a propulsion system carried by the body to propel the body during flight; a control system comprising a sensing system, a processor, and memory storing program instructions configured to cause the processor to determine a state estimate of the aerial vehicle within a region, a repulsion vector based on a repulsion potential field model of the region and the state estimate, and a collision avoidance velocity vector based on the repulsion vector and the state estimate; determine an input vector indicative of an intended angular velocity and an intended thrust of the vehicle based on pilot-operable control inputs; determine a control vector based on the collision avoidance velocity vector and the input vector; and control the propulsion system such that the manned VTOL aerial vehicle avoids an object in the region.

### TECHNICAL FIELD

Embodiments of this disclosure generally relate to aerial vehicles. In particular, embodiments of this disclosure relate to manned vertical take-off and landing aerial vehicle collision avoidance systems and methods.

### BACKGROUND

Aerial vehicles, such as manned vertical take-off and landing (VTOL) aerial vehicles, can collide with objects such as birds, walls, buildings or other aerial vehicles during flight. Collision with an object can cause damage to the aerial vehicle, particularly when the aerial vehicle is traveling at a high speed. Furthermore, collisions can be dangerous to people or objects nearby that can be hit by debris or the aerial vehicle itself. This can be a particularly large issue when high density airspace is considered.

A relatively large amount of aerial vehicles may occupy similar airspace and may travel along transverse flightpaths, increasing risks associated with collisions. Furthermore, manned aerial vehicles may also collide with objects because of other factors such as poor visibility, pilot error or slow pilot reaction time.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a vertical take-off and landing (VTOL) aerial vehicle. The VTOL aerial vehicle may comprise: a body; a propulsion system carried by the body to propel the body during flight; a control system comprising: a sensing system; at least one processor; and memory storing program instructions accessible by the at least one processor. In some embodiments, the program instructions are configured to cause the at least one processor to: determine a state estimate that is indicative of a state of the manned VTOL aerial vehicle within a region around the manned VTOL aerial vehicle, determine a collision avoidance velocity vector based at least in part on the state estimate; determine an input vector, the input vector being indicative of an intended angular velocity of the manned VTOL aerial vehicle and an intended thrust of the manned VTOL aerial vehicle; determine a control vector based at least in part on the collision avoidance velocity vector and the input vector; and control the propulsion system, based at least in part on the control vector, such that the manned VTOL aerial vehicle avoids the object.

Some embodiments relate to a vertical take-off and landing (VTOL) aerial vehicle. The VTOL aerial vehicle may comprise: a body; a propulsion system carried by the body to propel the body during flight; a control system comprising: a sensing system; at least one processor; and memory storing program instructions accessible by the at least one processor. In some embodiments, the program instructions are configured to cause the at least one processor to: determine a state estimate that is indicative of a state of the VTOL aerial vehicle within a region around the VTOL aerial vehicle, generate a repulsion potential field model of the region based at least in part on sensor data generated by the sensing system, wherein: the region comprises an object; and the repulsion potential field model is associated with an object state estimate that is indicative of a state of the object; determine a repulsion vector, based at least in part on the repulsion potential field model and the state estimate; determine a collision avoidance velocity vector based at least in part on the speed vector and the repulsion vector; determine an input vector, the input vector being indicative of an intended angular velocity of the VTOL aerial vehicle and an intended thrust of the VTOL aerial vehicle; determine a control vector based at least in part on the collision avoidance velocity vector and the input vector; and control the propulsion system, based at least in part on the control vector, such that the VTOL aerial vehicle avoids the object.

Some embodiments relate to a manned VTOL aerial vehicle comprising: a body; a propulsion system carried by the body, to propel the body during flight; a sensing system configured to generate sensor data; at least one processor; and memory storing program instructions accessible by the at least one processor. In some embodiments, the program instructions are configured to cause the at least one processor to: generate a depth map based at least in part on the sensor data; generate a region point cloud based at least in part on the depth map; determine a state estimate and a state estimate confidence metric, based at least in part on the sensor data, wherein: the state estimate is indicative of a position, an attitude and a velocity of the manned VTOL aerial vehicle within the region; and the state estimate confidence metric is indicative of an error associated with the state estimate; determine an object state estimate of an object within the region; generate a repulsion potential field model of the region based at least in part on the sensor data, wherein the repulsion potential field model is associated with the object state estimate; determine a repulsion vector, based at least in part on the repulsion potential field model and the state estimate; determine a collision avoidance velocity vector based at least in part on the repulsion vector and the state estimate; determine a control vector based at least in part on the collision avoidance velocity vector and an input vector, the input vector being indicative of an intended angular velocity of the manned VTOL aerial vehicle and an intended thrust of the manned VTOL aerial vehicle; and control the propulsion system, based at least in part on the control vector, such that the manned VTOL aerial vehicle avoids the object.

Some embodiments relate to a manned vertical take-off and landing (VTOL) aerial vehicle. The manned VTOL aerial vehicle may comprise: a body comprising a cockpit; a propulsion system carried by the body to propel the body during flight; pilot-operable controls accessible from the cockpit; a control system comprising: a sensing system; at least one processor; and memory storing program instructions accessible by the at least one processor. The program instructions may be configured to cause the at least one processor to: determine a state estimate that is indicative of a state of the manned VTOL aerial vehicle within a region around the manned VTOL aerial vehicle, wherein the state estimate comprises: a position estimate that is indicative of a position of the manned VTOL aerial vehicle within the region; a speed vector that is indicative of a velocity of the manned VTOL aerial vehicle; and an attitude vector that is indicative of an attitude of the manned VTOL aerial vehicle; generate a repulsion potential field model of the region based at least in part on sensor data generated by the sensing system, wherein: the region comprises an object; and the repulsion potential field model is associated with an object state estimate that is indicative of a state of the object; determine a repulsion vector, based at least in part on the repulsion potential field model and the state estimate; determine a collision avoidance velocity vector based at least in part on the speed vector and the repulsion vector; determine an input vector based at least in part on input received by the pilot operable controls, the input vector being indicative of an intended angular velocity of the manned VTOL aerial vehicle and an intended thrust of the manned VTOL aerial vehicle; determine a control vector based at least in part on the collision avoidance velocity vector and the input vector; and control the propulsion system, based at least in part on the control vector, such that the manned VTOL aerial vehicle avoids the object.

In some embodiments, the sensing system comprises a Global Navigation Satellite System (GNSS) module configured to generate GNSS data. The GNSS data may be indicative of a latitude and a longitude of the manned VTOL aerial vehicle. The sensor data may comprise the GNSS data.

In some embodiments, determining the state estimate comprises determining the GNSS data; and determining the state estimate based at least in part on the GNSS data.

In some embodiments, the sensing system comprises one or more of: an altimeter configured to provide, to the at least one processor, altitude data that is indicative of an altitude of the manned VTOL aerial vehicle; an accelerometer configured to provide, to the at least one processor, accelerometer data that is indicative of an acceleration of the manned VTOL aerial vehicle; a gyroscope configured to provide, to the at least one processor, gyroscopic data that is indicative of an orientation of the manned VTOL aerial vehicle; and a magnetometer sensor configured to provide, to the at least one processor, magnetic field data that is indicative of an azimuth orientation of the manned VTOL aerial vehicle. The sensor data may comprise one or more of the altitude data, the acceleration data, the gyroscopic data and the magnetic field data.

In some embodiments, determining the state estimate comprises: determining one or more of the altitude data, accelerometer data, gyroscopic data and magnetic field data; and determining the state estimate based at least in part on one or more of the altitude data, the accelerometer data, the gyroscopic data and the magnetic field data.

In some embodiments, the sensing system comprises an imaging module configured to provide, to the at least one processor, image data that is associated with the region. In some embodiments, the sensor data comprises the image data.

In some embodiments, the imaging module comprises one or more of: a light detection and ranging (LIDAR) system configured to generate LIDAR data; a visible spectrum imaging module configured to generate visible spectrum image data; and a radio detecting and ranging (RADAR) system configured to generate RADAR data. In some embodiments, the image data comprises one or more of the LIDAR data, the visible image data and the RADAR data.

In some embodiments, determining the state estimate comprises determining one or more of the LIDAR data, visible spectrum image data and RADAR data; and determining the state estimate based at least part on one or more of the LIDAR data, the visible spectrum image data and the RADAR data. In some embodiments, determining the state estimate comprises visual odometry.

In some embodiments, determining the state estimate comprises: determining a longitudinal velocity estimate that is indicative of a longitudinal velocity of the manned VTOL aerial vehicle, based at least in part on image data captured by a ground-facing camera mounted on the manned VTOL aerial vehicle; determining an acceleration estimate that is indicative of an acceleration of the manned VTOL aerial vehicle, based at least in part on accelerometer data; determining an orientation estimate that is indicative of an orientation of the manned VTOL aerial vehicle, based at least in part on gyroscopic data; determining an azimuth orientation estimate of the manned VTOL aerial vehicle, based at least in part on magnetic field data; and determining an altitude estimate that is indicative of an altitude of the manned VTOL aerial vehicle, based at least in part on altitude data.

In some embodiments, determining the state estimate comprises: determining an egomotion estimate, based at least in part on image data captured by a forward-facing camera mounted on the manned VTOL aerial vehicle; determining an acceleration estimate that is indicative of an acceleration of the manned VTOL aerial vehicle, based at least in part on accelerometer data; determining an orientation estimate that is indicative of an orientation of the manned VTOL aerial vehicle, based at least in part on gyroscopic data; determining an azimuth orientation estimate of the manned VTOL aerial vehicle, based at least in part on magnetic field data; and determining an altitude estimate that is indicative of an altitude of the manned VTOL aerial vehicle, based at least in part on altitude data.

In some embodiments, determining the state estimate comprises generating a three-dimensional point cloud representing the region. In some embodiments, determining the state estimate comprises: determining an initial state estimate that is indicative of an estimated initial state of the manned VTOL aerial vehicle; comparing the three-dimensional point cloud to a three-dimensional model of the region; and determining an updated state estimate based at least in part on a result of the comparing. In some embodiments, the state estimate corresponds to the updated state estimate.

In some embodiments, the object state estimate comprises one or more of: an object position estimate that is indicative of a position of the object within the region; an object speed vector that is indicative of a velocity of the object; and an object attitude vector that is indicative of an attitude of the object. In some embodiments, the object state estimate is determined using the three-dimensional point cloud.

In some embodiments, determining the state estimate comprises one or more of: determining an initial state estimate that is indicative of an estimated state of the manned VTOL aerial vehicle at a first time; determining an egomotion estimate, based at least in part on image data captured by a front-facing camera, the egomotion estimate being indicative of movement of the manned VTOL aerial vehicle between the first time and a second time; determining an acceleration estimate that is indicative of an acceleration of the manned VTOL aerial vehicle between the first time and the second time; determining an orientation change estimate that is indicative of a change in orientation of the manned VTOL aerial vehicle between the first time and the second time; determining an azimuth change estimate that is indicative of a change in the azimuth of the manned VTOL aerial vehicle between the first time and the second time; and determining an altitude change estimate that is indicative of a change in altitude of the manned VTOL aerial vehicle between the first time and the second time; determining an updated state estimate based at least in part on the initial state estimate and one or more of the egomotion estimate, the acceleration estimate, the orientation change estimate, the azimuth change estimate and the altitude change estimate; and wherein the state estimate corresponds to the updated state estimate.

In some embodiments, generating the repulsion potential field model comprises defining a first software-defined virtual boundary of the potential field model. The first software-defined virtual boundary may surround the position estimate. A magnitude of the repulsion vector may be a maximum when the object position estimate is on or within the first software-defined virtual boundary.

In some embodiments, generating the repulsion potential field model comprises defining a second software-defined virtual boundary of the potential field model. The second software-defined virtual boundary may surround the position estimate and the first software-defined virtual boundary. The magnitude of the repulsion vector may be zero when the object position estimate is outside the second software-defined virtual boundary.

In some embodiments, the magnitude of the repulsion vector is based at least partially on: a distance between the object position estimate and the first software-defined virtual boundary in a measurement direction; and a distance between the object position estimate and the second software-defined virtual boundary in the measurement direction.

In some embodiments, the first software-defined virtual boundary is a super-ellipsoid and/or the second software-defined virtual boundary is a super-ellipsoid.

In some embodiments, determining the repulsion vector comprises determining a gradient of the repulsion potential field model at the position estimate.

In some embodiments, the region comprises a plurality of objects, the plurality of objects comprising the object.

In some embodiments, generating the repulsion potential field model comprises determining an object repulsion potential field model for each object of the plurality of objects. In some embodiments, generating the repulsion potential field model comprises summing the object repulsion potential field models.

In some embodiments, determining the repulsion vector comprises determining an object repulsion vector for each object of the plurality of objects, using the object repulsion potential field model of the respective object.

In some embodiments, a first sub-set of the plurality of objects are dynamic objects that move with respect to a fixed reference frame of the repulsion potential field model. In some embodiments, a second sub-set of the plurality of objects are static objects that do not move with respect to the fixed reference frame of the repulsion potential field model.

In some embodiments, the program instructions are further configured to cause the at least one processor to determine a summed object repulsion vector, the summed object repulsion vector being a sum of the object repulsion vectors of the static objects.

In some embodiments, the program instructions are further configured to cause the at least one processor to saturate a norm of the sum of the repulsion vectors of the static objects to a maximum repulsion vector norm; wherein the collision avoidance velocity vector is determined based at least in part on the saturated norm.

In some embodiments, saturating the norm of the sum of the repulsion vectors of the static objects to a maximum repulsion vector norm comprises: determining a norm of the summed object repulsion vector; determining a norm of each of the repulsion vectors; comparing the norms of each of the repulsion vectors to determine the maximum repulsion vector norm; saturating the summed object repulsion vector from the norm of the summed object repulsion vector to the maximum repulsion vector norm. In some embodiments, the collision avoidance velocity vector is determined based at least in part on: a sum of the repulsion vectors of the dynamic objects; and the saturated norm.

In some embodiments, determining the control vector comprises: scaling the input vector by a first scaling parameter to provide a scaled input vector; scaling the collision avoidance velocity vector by a second scaling parameter to generate a scaled collision avoidance velocity vector; and adding the scaled input vector to the scaled collision avoidance velocity vector.

In some embodiments, the first scaling parameter and the second scaling parameter add to 1. In some embodiments, the first scaling parameter is proportional to a distance between the object position estimate and the first software-defined virtual boundary when the object position estimate is within the second software-defined virtual boundary.

In some embodiments, the object is a virtual object that is defined, by the at least one processor, within the repulsion potential field model.

In some embodiments, determining the collision avoidance velocity vector comprises summing the speed vector and the repulsion vector.

Some embodiments relate to a computer-implemented method for controlling a manned VTOL aerial vehicle. The computer-implemented method may comprise: determining a state estimate that is indicative of a state of the manned VTOL aerial vehicle within a region around the manned VTOL aerial vehicle, wherein the state estimate comprises: a position estimate that is indicative of a position of the manned VTOL aerial vehicle within the region; a speed vector that is indicative of a velocity of the manned VTOL aerial vehicle; and an attitude vector that is indicative of an attitude of the manned VTOL aerial vehicle; generating a repulsion potential field model of the region, wherein: the region comprises an object; and the repulsion potential field model is associated with an object state estimate that is indicative of a state of the object; determining a repulsion vector, based at least in part on the repulsion potential field model and the state estimate; determining a collision avoidance velocity vector based at least in part on the speed vector and the repulsion vector; determine an input vector based at least in part on input from pilot operable controls of the manned VTOL aerial vehicle, the input vector being indicative of an intended angular velocity of the manned VTOL aerial vehicle and an intended thrust of the manned VTOL aerial vehicle; determining a control vector based at least in part on the collision avoidance velocity vector and the input vector; and controlling the manned VTOL aerial vehicle to avoid the object based at least in part on the control vector.

In some embodiments, determining the state estimate comprises determining Global Navigation Satellite System (GNSS) data that is indicative of a latitude, a longitude and/or an altitude of the manned VTOL aerial vehicle; and determining the state estimate based at least in part on the GNSS data.

In some embodiments, determining the state estimate comprises determining one or more of: altitude data that is indicative of an altitude of the manned VTOL aerial vehicle; accelerometer data that is indicative of an acceleration of the manned VTOL aerial vehicle; gyroscopic data that is indicative of an orientation of the manned VTOL aerial vehicle; and magnetic field data that is indicative of an azimuth orientation of the manned VTOL aerial vehicle; and determining the state estimate based at least in part on one or more of the accelerometer data, the gyroscopic data and the magnetic field data.

In some embodiments, determining the state estimate comprises determining one or more of LIDAR data, visible spectrum image data and RADAR data; and determining the state estimate based at least in part on one or more of the LIDAR data, the visible spectrum image data and the RADAR data. In some embodiments, determining the state estimate comprises visual odometry.

In some embodiments, determining the state estimate comprises: determining a longitudinal velocity estimate that is indicative of a longitudinal velocity of the manned VTOL aerial vehicle, based at least in part on image data captured by a ground-facing camera mounted on the manned VTOL aerial vehicle; determining an acceleration estimate that is indicative of an acceleration of the manned VTOL aerial vehicle, based at least in part on accelerometer data; determining an orientation estimate that is indicative of an orientation of the manned VTOL aerial vehicle, based at least in part on gyroscopic data; determining an azimuth orientation estimate of the manned VTOL aerial vehicle, based at least in part on magnetic field data; and determining altitude data that is indicative of an altitude of the manned VTOL aerial vehicle, based at least in part on altitude data.

In some embodiments, determining the state estimate comprises: determining an egomotion estimate, based at least in part on image data captured by a front-facing camera mounted on the manned VTOL aerial vehicle; determining an acceleration estimate that is indicative of an acceleration of the manned VTOL aerial vehicle, based at least in part on accelerometer data; determining an orientation estimate that is indicative of an orientation of the manned VTOL aerial vehicle, based at least in part on gyroscopic data; determining an azimuth orientation estimate of the manned VTOL aerial vehicle, based at least in part on magnetic field data; and determining altitude data that is indicative of an altitude of the manned VTOL aerial vehicle, based at least in part on altitude data.

In some embodiments, determining the state estimate comprises generating a three-dimensional point cloud representing the region. In some embodiments, determining the state estimate comprises: determining an initial state estimate that is indicative of an estimated initial state of the manned VTOL aerial vehicle; comparing the three-dimensional point cloud to a three-dimensional model of the region; and determining an updated state estimate based at least in part on a result of the comparing. In some embodiments, the state estimate corresponds to the updated state estimate.

In some embodiments, the object state estimate comprises one or more of: an object position estimate that is indicative of a position of the object within the region; an object speed estimate that is indicative of a velocity of the object; and an object attitude estimate that is indicative of an attitude of the object. In some embodiments, the object state estimate is determined using the three-dimensional point cloud.

In some embodiments, determining the state estimate comprises one or more of: determining an initial state estimate that is indicative of an estimated state of the manned VTOL aerial vehicle at a first time; determining an egomotion estimate, based at least in part on image data captured by a front-facing camera, the egomotion estimate being indicative of movement of the manned VTOL aerial vehicle between the first time and a second time; determining an acceleration estimate that is indicative of an acceleration of the manned VTOL aerial vehicle between the first time and a second time; determining an orientation change estimate that is indicative of a change in orientation of the manned VTOL aerial vehicle between the first time and the second time; determining an azimuth change estimate that is indicative of a change in the azimuth of the manned VTOL aerial vehicle between the first time and the second time; and determining an altitude change estimate that is indicative of a change in altitude of the manned VTOL aerial vehicle between the first time and the second time; determining an updated state estimate based at least in part on the initial state estimate and one or more of the egomotion estimate, the acceleration estimate, the orientation change estimate, the azimuth change estimate and the altitude change estimate; and wherein the state estimate corresponds to the updated state estimate.

In some embodiments, generating the repulsion potential field model comprises defining a first software-defined virtual boundary of the potential field model. In some embodiments, the first software-defined virtual boundary may surround the position estimate. A magnitude of the repulsion vector may be a maximum when the object position estimate is on or within the first software-defined virtual boundary.

In some embodiments, generating the repulsion potential field model comprises defining a second software-defined virtual boundary of the potential field model. The second software-defined virtual boundary may surround the position estimate and the first software-defined virtual boundary. The magnitude of the repulsion vector may be zero when the object position estimate is outside the second software-defined virtual boundary.

In some embodiments, the magnitude of the repulsion vector is based at least partly on: a distance between the object position estimate and the first software-defined virtual boundary in a measurement direction; and a distance between the object position estimate and the second software-defined virtual boundary in the measurement direction.

In some embodiments, the first software-defined virtual boundary is a super-ellipsoid and/or the second software-defined virtual boundary is a super-ellipsoid.

In some embodiments, determining the repulsion vector comprises determining a gradient of the repulsion potential field model at the position estimate.

In some embodiments, the region comprises a plurality of objects, the plurality of objects comprising the object.

In some embodiments, generating the repulsion potential field model comprises determining an object repulsion potential field model for each object of the plurality of objects. In some embodiments, generating the repulsion potential field model comprises summing the object repulsion potential field models.

In some embodiments, determining the repulsion vector comprises determining an object repulsion vector for each object using the object repulsion potential field model of the respective object. In some embodiments, determining the object repulsion vector for one object of the plurality of objects comprises determining a gradient of the object repulsion potential field model of that object, at the position estimate.

In some embodiments, a first sub-set of the plurality of objects are dynamic objects that move with respect to a fixed reference frame of the repulsion potential field model. In some embodiments, a second sub-set of the plurality of objects are static objects that do not move with respect to the fixed reference frame of the repulsion potential field model.

In some embodiments, the method further comprises determining a summed object repulsion vector, the summed object repulsion vector being a sum of the object repulsion vectors of the static objects.

In some embodiments, the method further comprises saturating a norm of the sum of the repulsion vectors of the static objects to a maximum repulsion vector norm; wherein the control vector is determined based at least in part on the saturated norm.

In some embodiments, saturating the norm of the sum of the repulsion vectors of the static objects to a maximum repulsion vector norm comprises: determining a norm of the summed object repulsion vector; determining a norm of each of the repulsion vectors; comparing the norms of each of the repulsion vectors to determine the maximum repulsion vector norm; saturating the summed object repulsion vector from the norm of the summed object repulsion vector to the maximum repulsion vector norm.

In some embodiments, the control vector is determined based at least in part on: a sum of the repulsion vectors of the dynamic objects; and the saturated norm.

In some embodiments, determining the control vector comprises: scaling the input vector by a first scaling parameter to provide a scaled input vector; scaling the collision avoidance velocity vector by a second scaling parameter to generate a scaled collision avoidance velocity vector; and adding the scaled input vector to the scaled collision avoidance velocity vector.

In some embodiments, the first scaling parameter and the second scaling parameter add to 1. In some embodiments, the first scaling parameter is proportional to a distance between the object position estimate and the first software-defined virtual boundary when the object position estimate is within the second software-defined virtual boundary.

In some embodiments, the object is a virtual object that is defined within the repulsion potential field model.

In some embodiments, determining the collision avoidance velocity vector comprises summing the speed vector and the repulsion vector.

Some embodiments relate to a manned VTOL aerial vehicle. The manned VTOL aerial vehicle may comprise: a body comprising a cockpit; a propulsion system carried by the body, to propel the body during flight; pilot-operable controls accessible from the cockpit; a sensing system configured to generate sensor data, the sensing system comprising: a GNSS module configured to generate GNSS data that is indicative of a latitude and a longitude of the manned VTOL aerial vehicle within a region; a LIDAR system configured to generate LIDAR data associated with the region; a visible spectrum camera configured to generate visible spectrum image data associated with the region; a gyroscope configured to generate gyroscopic data that is indicative of an orientation of the manned VTOL aerial vehicle; an accelerometer configured to generate accelerometer data that is indicative of an acceleration of the manned VTOL aerial vehicle; an altimeter configured to generate altitude data that is indicative of an altitude of the manned VTOL aerial vehicle; a magnetometer sensor configured to generate magnetic field data that is indicative of an azimuth orientation of the manned VTOL aerial vehicle; at least one processor; and memory storing program instructions accessible by the at least one processor. The program instructions may be configured to cause the at least one processor to: generate a depth map based at least in part on the visible spectrum image data; generate a region point cloud based at least in part on the depth map and the LIDAR data; determine a first state estimate and a first state estimate confidence metric, based at least in part on the gyroscopic data, the accelerometer data, the altitude data, the magnetic field data and the visible spectrum image data, wherein: the first state estimate is indicative of a first position, a first attitude and a first velocity of the manned VTOL aerial vehicle within the region; and the first state estimate confidence metric is indicative of a first error associated with the first state estimate; determine a second state estimate and a second state estimate confidence metric, based at least in part on the region point cloud, the first state estimate and the first state estimate confidence metric, wherein: the second state estimate is indicative of a second position, a second attitude and a second velocity of the manned VTOL aerial vehicle within the region; and the second state estimate confidence metric is indicative of a second error associated with the second state estimate; determine a third state estimate and a third state estimate confidence metric, based at least in part on the GNSS data, the gyroscopic data, the accelerometer data, the altitude data, the magnetic field data, the second state estimate and the second state estimate confidence metric, wherein: the third state estimate comprises: a position estimate that is indicative of a position of the manned VTOL aerial vehicle within the region; a speed vector that is indicative of a velocity of the manned VTOL aerial vehicle; and an attitude vector that is indicative of an attitude of the manned VTOL aerial vehicle; and the third state estimate confidence metric is indicative of a third error associated with the third state estimate; determine an object state estimate of an object within the region; generate a repulsion potential field model of the region based at least in part on the sensor data, wherein the repulsion potential field model is associated with the object state estimate; determine a repulsion vector, based at least in part on the repulsion potential field model and the third state estimate; determine a collision avoidance velocity vector based at least in part on the repulsion vector and the third state estimate; determine a control vector based at least in part on the collision avoidance velocity vector and an input vector, the input vector being received via the pilot operable controls, and being indicative of an intended angular velocity of the manned VTOL aerial vehicle and an intended thrust of the manned VTOL aerial vehicle; and control the propulsion system, based at least in part on the control vector, such that the manned VTOL aerial vehicle avoids the object.

In some embodiments, the depth map is generated using a deep neural network (DNN). In some embodiments, generating the region point cloud comprises merging the depth map and the LIDAR data. In some embodiments, outlier points of the depth map and/or the LIDAR data are excluded from the region point cloud.

In some embodiments, the first state estimate and the first state estimate confidence metric are determined using visual odometry.

In some embodiments, determining the second state estimate and the second state estimate confidence metric comprises three-dimensional adaptive Monte Carlo localisation.

In some embodiments, the region point cloud, the first state estimate and the first state estimate confidence metric are inputs of the three-dimensional adaptive Monte Carlo localisation.

In some embodiments, the program instructions are further configured to cause the at least one processor to receive external LIDAR data from an external LIDAR data source, the external LIDAR data comprising an external region point cloud representing the region. In some embodiments, the external LIDAR data is an input of the three-dimensional adaptive Monte Carlo localisation.

In some embodiments, the second state estimate and the second state estimate confidence interval are outputs of the three-dimensional adaptive Monte Carlo localisation.

In some embodiments, determining the third state estimate and the third state estimate confidence metric comprises using an Extended Kalman Filter. In some embodiments, the second state estimate, the second state estimate confidence metric, the gyroscopic data, the accelerometer data, the altitude data, the magnetic field data and the GNSS data are inputs of the Extended Kalman Filter.

In some embodiments, the program instructions are further configured to cause the at least one processor to receive a ground-based state estimate that is indicative of a state of the manned VTOL aerial vehicle. In some embodiments, the ground-based state estimate is an input of the Extended Kalman Filter. In some embodiments, the third state estimate and the third state estimate confidence metric are outputs of the Extended Kalman Filter.

In some embodiments, the object state estimate comprises one or more of: an object position estimate that is indicative of a position of the object within the region; an object speed estimate that is indicative of a velocity of the object; and an object attitude estimate that is indicative of an attitude of the object. In some embodiments, the object state estimate is determined using the external LIDAR data.

In some embodiments, generating the repulsion potential field model comprises defining a first software-defined virtual boundary of the potential field model. In some embodiments, the first software-defined virtual boundary may surround the position estimate. In some embodiments, a magnitude of the repulsion vector is a maximum when the object position estimate is on or within the first software-defined virtual boundary.

In some embodiments, generating the repulsion potential field model comprises defining a second software-defined virtual boundary of the potential field model. In some embodiments, the second software-defined virtual boundary may surround the position estimate and the first software-defined virtual boundary. In some embodiments, the magnitude of the repulsion vector is zero when the object position estimate is outside the second software-defined virtual boundary.

In some embodiments, the magnitude of the repulsion vector is based at least partly on: a distance between the object position estimate and the first software-defined virtual boundary in a measurement direction; and a distance between the object position estimate and the second software-defined virtual boundary in the measurement direction.

In some embodiments, the first software-defined virtual boundary is a super-ellipsoid and/or the second software-defined virtual boundary is a super-ellipsoid.

In some embodiments, determining the repulsion vector comprises determining a gradient of the repulsion potential field model at the position estimate. In some embodiments, determining the collision avoidance velocity vector comprises summing the speed vector and the repulsion vector. In some embodiments, determining the control vector comprises: scaling the input vector by a first scaling parameter to provide a scaled input vector; scaling the collision avoidance velocity vector by a second scaling parameter to generate a scaled collision avoidance velocity vector; and adding the scaled input vector to the scaled collision avoidance velocity vector.

In some embodiments, the first scaling parameter and the second scaling parameter add to 1. In some embodiments, the first scaling parameter is proportional to a distance between the object position estimate and the first software-defined virtual boundary when the object position estimate is within the second software-defined virtual boundary.

In some embodiments, the object is a virtual object that is defined, by the at least one processor, within the repulsion potential field model.

Some embodiments relate to a computer-implemented method for controlling a manned VTOL aerial vehicle. The computer-implemented method may comprise: generating a depth map based at least in part on visible spectrum image data; generating a region point cloud based at least in part on the depth map and LIDAR data; determining a first state estimate and a first state estimate confidence metric, based at least in part on gyroscopic data, accelerometer data, altitude data, magnetic field data and the visible spectrum image data, wherein: the first state estimate is indicative of a first position, a first attitude and a first velocity of the manned VTOL aerial vehicle within a region; and the first state estimate confidence metric is indicative of a first error associated with the first state estimate; determining a second state estimate and a second state estimate confidence metric, based at least in part on the region point cloud, the first state estimate and the first state estimate confidence metric, wherein: the second state estimate is indicative of a second position, a second attitude and a second velocity of the manned VTOL aerial vehicle within the region; and the second state estimate confidence metric is indicative of a second error associated with the second state estimate; determining a third state estimate and a third state estimate confidence metric, based at least in part on GNSS data, the gyroscopic data, the accelerometer data, the altitude data, the magnetic field data, the second state estimate and the second state estimate confidence metric, wherein: the third state estimate comprises: a position estimate that is indicative of a position of the manned VTOL aerial vehicle within the region; a speed vector that is indicative of a velocity of the manned VTOL aerial vehicle; and an attitude vector that is indicative of an attitude of the manned VTOL aerial vehicle; and the third state estimate confidence metric is indicative of a third error associated with the third state estimate; determining an object state estimate of an object within the region; generating a repulsion potential field model of the region, wherein the repulsion potential field model is associated with the object state estimate; determining a repulsion vector, based at least in part on the repulsion potential field model and the third state estimate; determining a collision avoidance velocity vector based at least in part on the repulsion vector and the third state estimate; determining a control vector based at least in part on the collision avoidance velocity vector and an input vector, the input vector being indicative of an intended angular velocity of the manned VTOL aerial vehicle and an intended thrust of the manned VTOL aerial vehicle; and controlling a propulsion system of the manned VTOL aerial vehicle, based at least in part on the control vector, such that the manned VTOL aerial vehicle avoids the object.

In some embodiments, the depth map is generated using a deep neural network (DNN). In some embodiments, generating the region point cloud comprises merging the depth map and the LIDAR data. In some embodiments, outlier points of the depth map and/or the LIDAR data are excluded from the region point cloud.

In some embodiments, the first state estimate and the first state estimate confidence metric are determined using visual odometry.

In some embodiments, determining the second state estimate and the second state estimate confidence metric comprises three-dimensional adaptive Monte Carlo localisation. In some embodiments, the region point cloud, the first state estimate and the first state estimate confidence metric are inputs of the three-dimensional adaptive Monte Carlo localisation.

In some embodiments, the computer-implemented method further comprises receiving, by the at least one processor, external LIDAR data, from an external LIDAR data source, the external LIDAR data comprising an external region point cloud representing the region. In some embodiments, the external LIDAR data is an input of the three-dimensional adaptive Monte Carlo localisation. In some embodiments, the second state estimate and the second state estimate confidence interval are outputs of the three-dimensional adaptive Monte Carlo localisation.

In some embodiments, determining the third state estimate and the third state estimate confidence metric comprises using an Extended Kalman Filter. In some embodiments, the second state estimate, the second state estimate confidence metric, the gyroscopic data, the accelerometer data, the altitude data and the GNSS data are inputs of the Extended Kalman Filter.

In some embodiments, the computer-implemented method further comprises receiving, by the at least one first processor, a ground-based state estimate that is indicative of a state of the manned VTOL aerial vehicle. In some embodiments, the ground-based state estimate is an input of the Extended Kalman Filter. In some embodiments, the third state estimate and the third state estimate confidence metric are outputs of the Extended Kalman Filter.

In some embodiments, wherein the object state estimate comprises one or more of: an object position estimate that is indicative of a position of the object within the region; an object speed estimate that is indicative of a velocity of the object; and an object attitude estimate that is indicative of an attitude of the object. In some embodiments, the object state estimate is determined using the external LIDAR data.

In some embodiments, generating the repulsion potential field model comprises defining a first software-defined virtual boundary of the potential field model. In some embodiments, the first software-defined virtual boundary may surround the position estimate. In some embodiments, a magnitude of the repulsion vector is a maximum when the object position estimate is on or within the first software-defined virtual boundary.

In some embodiments, generating the repulsion potential field model comprises defining a second software-defined virtual boundary of the potential field model. In some embodiments, the second software-defined virtual boundary may surround the position estimate and the first software-defined virtual boundary. In some embodiments, wherein the magnitude of the repulsion vector is zero when the object position estimate is outside the second software-defined virtual boundary.

In some embodiments, the magnitude of the repulsion vector is based at least partly on: a distance between the object position estimate and the first software-defined virtual boundary in a measurement direction; and a distance between the object position estimate and the second software-defined virtual boundary in the measurement direction.

In some embodiments, the first software-defined virtual boundary is a super-ellipsoid and/or the second software-defined virtual boundary is a super-ellipsoid.

In some embodiments, determining the repulsion vector comprises determining a gradient of the repulsion potential field model at the position estimate.

In some embodiments, determining the collision avoidance velocity vector comprises summing the speed vector and the repulsion vector.

In some embodiments, determining the control vector comprises: scaling the input vector by a first scaling parameter to provide a scaled input vector; scaling the collision avoidance velocity vector by a second scaling parameter to generate a scaled collision avoidance velocity vector; and adding the scaled input vector to the scaled collision avoidance velocity vector.

In some embodiments, the first scaling parameter and the second scaling parameter add to 1. In some embodiments, the first scaling parameter is proportional to a distance between the object position estimate and the first software-defined virtual boundary when the object position estimate is within the second software-defined virtual boundary.

In some embodiments, the object is a virtual object that is defined, by the at least one processor, within the repulsion potential field model.

### BRIEF DESCRIPTION OF DRAWINGS

Embodiments of the present disclosure will now be described by way of non-limiting example only, with reference to the accompanying drawings, in which:

FIG. 1 is a front perspective view of a manned VTOL aerial vehicle, according to some embodiments;

FIG. 2 is a rear perspective view of the manned VTOL aerial vehicle, according to some embodiments;

FIG. 3 is a block diagram of an aerial vehicle system, according to some embodiments;

FIG. 4 is a block diagram of a control system of the manned VTOL aerial vehicle, according to some embodiments;

FIG. 5 is a block diagram of an alternative control system of the manned VTOL aerial vehicle, according to some embodiments;

FIG. 6 is a block diagram of a sensing system of the manned VTOL aerial vehicle, according to some embodiments;

FIG. 7 is a front perspective view of a manned VTOL aerial vehicle, showing example positions of a plurality of sensors of a sensing module, according to some embodiments;

FIG. 8 is a process flow diagram of a computer-implemented method for controlling the manned VTOL aerial vehicle, according to some embodiments;

FIG. 9 is a process flow diagram of a computer-implemented method for determining a state estimate of the manned VTOL aerial vehicle, according to some embodiments;

FIG. 10 illustrates the manned VTOL aerial vehicle in a region comprising an object, according to some embodiments;

FIG. 11 illustrates the manned VTOL aerial vehicle in a region comprising a plurality of objects, according to some embodiments;

FIG. 12 illustrates the manned VTOL aerial vehicle with respect to a plurality of software-defined virtual boundaries and a plurality of possible object positions;

FIG. 13 is a chart illustrating variation of a magnitude of a scaling parameter;

FIG. 14 is a schematic diagram of a portion of a control system, according to some embodiments;

FIG. 15 is a schematic diagram of another portion of the control system of FIG. 14, according to some embodiments;

FIG. 16 is a schematic diagram of a portion of a control system, according to some embodiments;

FIG. 17 is a schematic diagram of another portion of the control system of FIG. 16;

FIG. 18 is a schematic diagram of a control system, according to some embodiments;

FIG. 19 is a schematic diagram of a portion of a control system, according to some embodiments;

FIG. 20 is a schematic diagram of a portion of a control system, according to some embodiments;

FIG. 21 is a block diagram of a propulsion system, according to some embodiments;

FIG. 22 is a schematic diagram of a portion of an alternate control system, according to some embodiments; and

FIG. 23 is a schematic diagram of another portion of the alternate control system, according to some embodiments.

### DESCRIPTION OF EMBODIMENTS

Manned vertical take-off and landing (VTOL) aerial vehicles are used in a number of applications. For example, competitive manned VTOL aerial vehicle racing can involve a plurality of manned VTOL aerial vehicles navigating a track, each with a goal of navigating the track in the shortest amount of time. The track may have a complex shape, may cover a large area and/or may include a number of obstacles around which the manned VTOL aerial vehicles must navigate (including other vehicles), for example.

It is important to minimise the likelihood of manned VTOL aerial vehicles colliding, either with other vehicles or objects. For example, in the context of racing, it is important that the manned VTOL aerial vehicles do not collide with other vehicles in the race or objects associated with the track (e.g. the ground, walls, trees, unmanned autonomous aerial vehicles, birds etc.). Furthermore, the track may include virtual objects that are visible, for example, through a heads-up display (HUD) and avoiding these virtual objects is also important. Collision with an object can cause damage to the manned VTOL aerial vehicle, particularly when the manned VTOL aerial vehicle is traveling at a high speed. Furthermore, collisions can be dangerous to people or objects nearby that can be hit by debris or the manned VTOL aerial vehicle itself

A significant technical problem exists in providing a manned VTOL aerial vehicle that a pilot can navigate across a region (e.g. the track) whilst minimising the risk that the manned VTOL aerial vehicle crashes (e.g. due to pilot error, equipment failure etc.).

### Manned Vertical Take-Off and Landing Aerial Vehicle

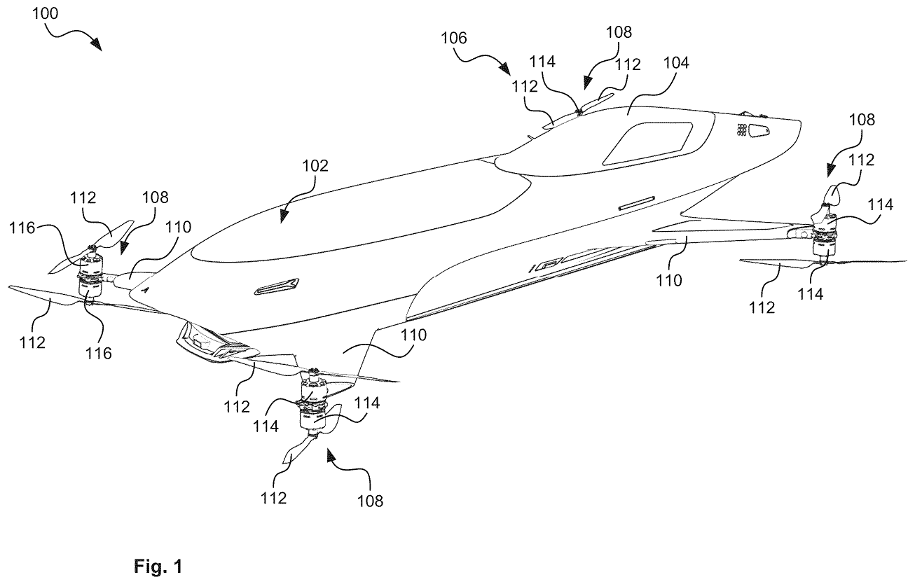

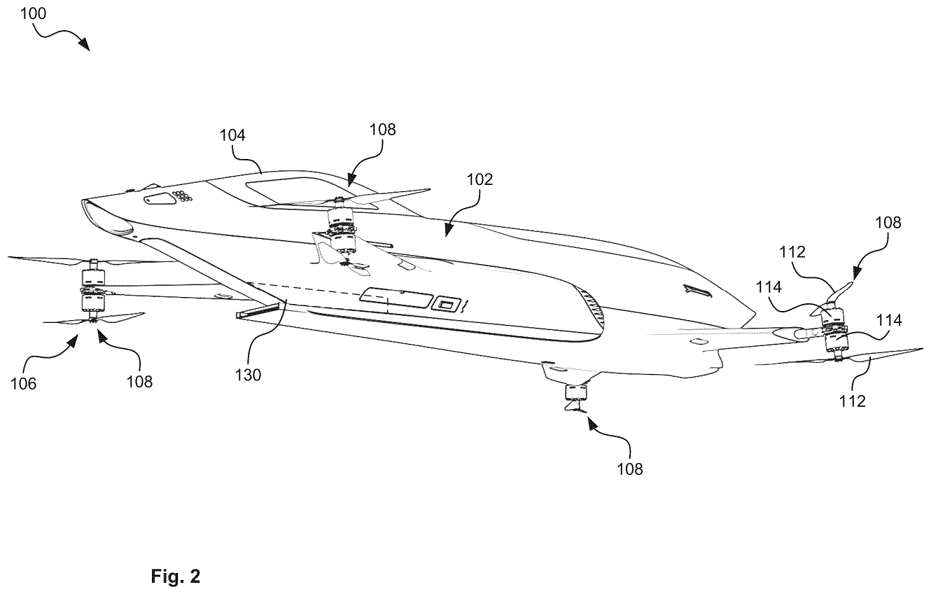

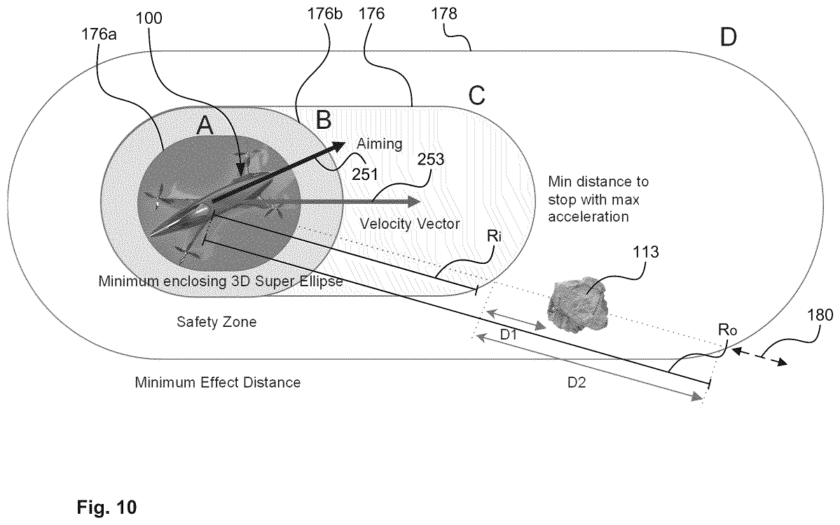

FIG. 1 illustrates a front perspective view of a manned vertical take-off and landing aerial vehicle 100. FIG. 2 illustrates a rear perspective view of the manned VTOL aerial vehicle 100. The manned VTOL aerial vehicle 100 is configured to move within a region. Specifically, the manned VTOL aerial vehicle 100 is configured to fly within a region that comprises an object 113 (FIG. 10). In some embodiments, the manned VTOL aerial vehicle 100 may be referred to as a speeder.

The manned VTOL aerial vehicle 100 is a rotary wing vehicle. The manned VTOL aerial vehicle 100 can move omnidirectionally in a three-dimensional space. In some embodiments, the manned VTOL aerial vehicle 100 has a constant deceleration limit.

The manned VTOL aerial vehicle 100 comprises a body 102. The body 102 may comprise a fuselage. The body 102 comprises a cockpit 104 sized and configured to accommodate a human pilot. The cockpit 104 comprises a display (not shown). The display is configured to display information to the pilot. The display may be implemented as a heads-up display, an electroluminescent (ELD) display, a light-emitting diode (LED) display, a quantum dot (QLED) display, an organic light-emitting diode (OLED) display, a liquid crystal display, a plasma screen, a cathode ray screen device, a combination of such displays or the like.

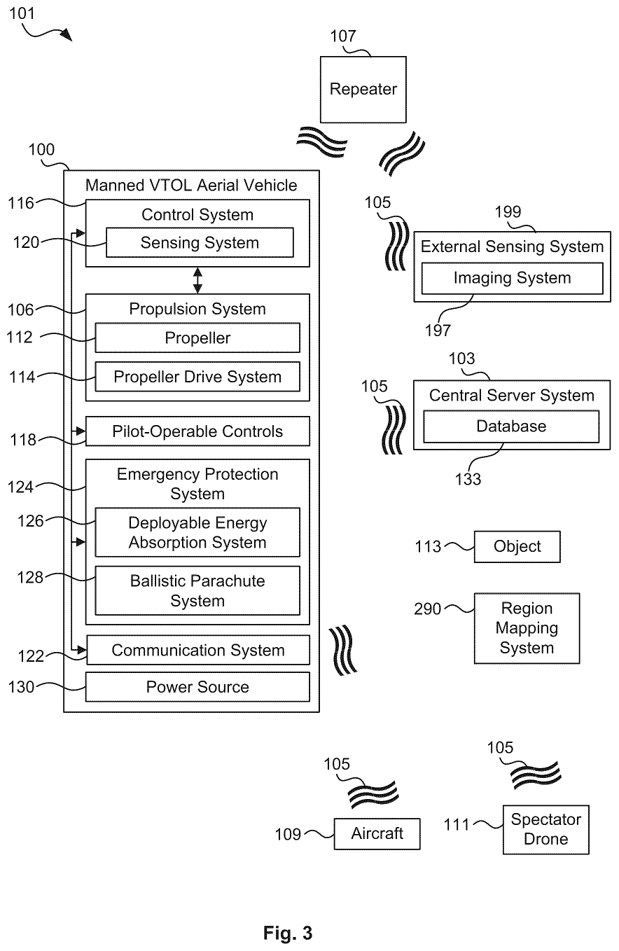

In some embodiments, the body 102 comprises, or is in the form of a monocoque. For example, the body 102 may comprise or be in the form of a carbon fibre monocoque. The manned VTOL aerial vehicle 100 comprises pilot-operable controls 118 (FIG. 3) that are accessible from the cockpit 104. The manned VTOL aerial vehicle 100 comprises a propulsion system 106. The propulsion system 106 is carried by the body 102 to propel the body 102 during flight.

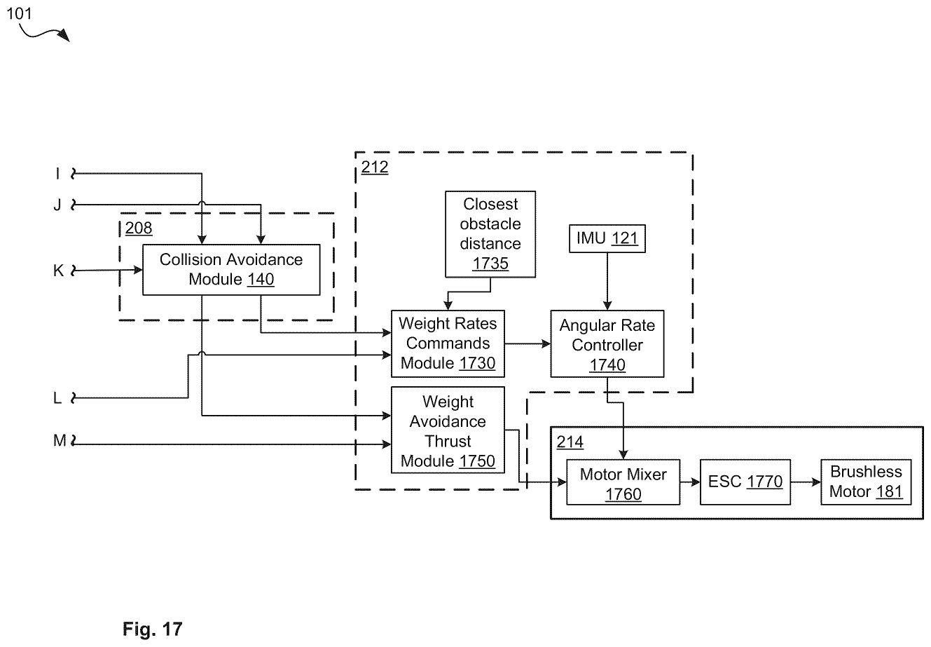

The propulsion system 106 (FIG. 21) comprises a propeller system 108. The propeller system 108 comprises a propeller 112 and a propeller drive system 114. The propeller system 108 comprises multiple propellers 112 and a propeller drive system 114 for each propeller 112. The propeller drive system 114 comprises a propeller motor. The propeller drive system 114 may comprise a brushless motor 181 (FIG. 17). In other words, the propeller drive system 114 may comprise a motor. The motor may be a brushless motor 181. The propeller motor may be controlled via an electronic speed control 1770 (ESC) circuit for each propeller 112 of the propeller system 108.

The propulsion system 106 of the manned VTOL aerial vehicle 100 illustrated in FIG. 1 and FIG. 2 comprises a plurality of propeller systems 108. In particular, the propulsion system 106 of the manned VTOL aerial vehicle 100 illustrated in FIG. 1 and FIG. 2 comprises four propeller systems 108. Each propeller system 108 comprises a first propeller and a first propeller drive system. Each propeller system 108 also comprises a second propeller and a second propeller drive system. The first propeller drive system is configured to selectively rotate the first propeller in a first direction of rotation or a second direction opposite the first direction. The second propeller drive system is configured to selectively rotate the second propeller in the first direction of rotation or the second direction.

Each propeller system 108 is connected to a respective elongate body portion 110 of the body 102. The elongate body portions 110 may be referred to as “arms” of the body 102. Each propeller system 108 is mounted to the body 102 such that the propeller systems 108 form a generally quadrilateral profile.

By selective control of the propeller systems 108, the manned VTOL aerial vehicle 100 can be accurately controlled to move within three-dimensional space. The manned VTOL aerial vehicle 100 is capable of vertical take-off and landing.

FIG. 3 is a block diagram of an aerial vehicle system 101, according to some embodiments. The aerial vehicle system 101 comprises the manned VTOL aerial vehicle 100. As previously described, the manned VTOL aerial vehicle 100 comprises a propulsion system 106 that comprises a plurality of propellers 112 and propeller drive systems 114. The manned VTOL aerial vehicle 100 comprises a control system 116. The control system 116 is configured to communicate with the propulsion system 106. In particular, the control system 116 is configured to control the propulsion system 106 so that the propulsion system 106 can selectively propel the body 102 during flight.

The manned VTOL aerial vehicle 100 comprises a sensing system 120. In particular, the control system 116 comprises the sensing system 120. The sensing system 120 is configured to generate sensor data. The control system 116 is configured to process the sensor data to control the manned VTOL aerial vehicle 100.

The manned VTOL aerial vehicle 100 comprises pilot-operable controls 118. A pilot can use the pilot-operable controls 118 to control the manned VTOL aerial vehicle 100 in flight. The pilot-operable controls are configured to communicate with the control system 116. In particular, the control system 116 processes input data generated by actuation of the pilot-operable controls 118 by the pilot to control the manned VTOL aerial vehicle 100. The control system 116 is configured to process the input data generated by the actuation of the pilot-operable controls 118. In some embodiments, the input data is in the form of an input vector. The input data may be indicative of an intended control velocity of the manned VTOL aerial vehicle 100, as is described in more detail herein.

The manned VTOL aerial vehicle 100 comprises a communication system 122. The communication system 122 is configured to communicate with the control system 116. The manned VTOL aerial vehicle 100 is configured to communicate with other computing devices using the communication system 122. The communication system 122 may comprise a vehicle network interface 155. The vehicle network interface 155 is configured to enable the manned VTOL aerial vehicle 100 to communicate with other computing devices using one or more communications networks. The vehicle network interface 155 may comprise a combination of network interface hardware and network interface software suitable for establishing, maintaining and facilitating communication over a relevant communication channel. Examples of a suitable communications network include a cloud server network, a wired or wireless internet connection, a wireless local area network (WLAN) such as Wi-Fi (IEEE 802.11) or Zigbee (IEEE 802.15.4), a wireless wide area network (WWAN) such as cellular 4G LTE and 5G or another cellular network connection, low power wide area networks (LPWAN) such as SigFox and Lora, Bluetooth™ or other near field radio communication, and/or physical media such as a Universal Serial Bus (USB) connection.

The manned VTOL aerial vehicle 100 also comprises an internal communication network (not shown). The internal communication network is a wired network. The internal communication network connects the at least one processor 132, memory 134 and other components of the manned VTOL aerial vehicle 100 such as the propulsion system 106. The internal communication network may comprise a serial link, Ethernet network, a controlled area network (CAN) or another network.

The manned VTOL aerial vehicle 100 comprises an emergency protection system 124. The emergency protection system 124 is in communication with the control system 116. The emergency protection system 124 is configured to protect the pilot and/or the manned VTOL aerial vehicle 100 in a case where the manned VTOL aerial vehicle 100 is in a collision. That is, the control system 116 may deploy one or more aspects of the emergency protection system 124 to protect the pilot and/or the manned VTOL aerial vehicle 100.

The emergency protection system 124 comprises a deployable energy absorption system 126. In some embodiments, the deployable energy absorption system 126 comprises an airbag. The deployable energy absorption system 126 is configured to deploy in the case where the manned VTOL aerial vehicle 100 is in a collision. The deployable energy absorption system 126 may deploy if an acceleration of the manned VTOL aerial vehicle 100 exceeds an acceleration threshold. For example, the deployable energy absorption system 126 may deploy if the control system 116 senses or determines a deceleration magnitude of the manned VTOL aerial vehicle 100 that is indicative of a magnitude of a deceleration of the manned VTOL aerial vehicle 100 is greater than a predetermined deceleration magnitude threshold.

The emergency protection system 124 comprises a ballistic parachute system 128. The ballistic parachute system 128 is configured to deploy to protect the pilot and/or the manned VTOL aerial vehicle 100 in a number of conditions. These may include the case where the manned VTOL aerial vehicle 100 is in a collision, or where the propulsion system 106 malfunctions. For example, if one or more of the propeller drive systems 114 fail and the manned VTOL aerial vehicle 100 is unable to be landed safely, the ballistic parachute system 128 may deploy to slow the descent of the manned VTOL aerial vehicle 100. In some cases, the ballistic parachute system 128 is configured to deploy if two propeller drive systems 114 on one elongate body portion 110 fail.

The manned VTOL aerial vehicle 100 comprises a power source 130. The power source 130 may comprise one or more batteries. The one or more batteries are electric batteries and carry sufficient charge to power the vehicle 100 for multiple minutes of manned flight, preferably at least 15 minutes to 30 minutes or more of flight time. For example, the manned VTOL aerial vehicle 100 may comprise one or more batteries that are stored in a lower portion of the body 102. For example, as shown in FIG. 2, the one or more batteries may be stored below the cockpit 104. Each battery may be readily manually replaceable with a fresh (fully charged) battery during a rest stop of the vehicle 100 without the need to disassemble the fuselage of the vehicle 100. In other words, the battery can be a cartridge style battery module that can be hot-swapped for speedy replacement during a race.

The power source 130 is configured to power each sub-system of the manned VTOL aerial vehicle 100 (e.g. the control system 116, propulsion system 106 etc.). The manned VTOL aerial vehicle 100 comprises a battery management system. The battery management system is configured to estimate a charge state of the one or more batteries. The battery management system is configured to perform battery balancing. The battery management system is configured to monitor the health of the one or more batteries. The battery management system is configured to monitor the temperature of the one or more batteries. The battery management system is configured to monitor the tension of the one or more batteries. The battery management system is configured to isolate a battery of the one or more batteries from a load, if required. The battery management system is configured to saturate an input power of the one or more batteries. The battery management system is configured to saturate an output power of the one or more batteries.

The aerial vehicle system 101 also comprises a central server system 103. The central server system 103 is configured to communicate with the manned VTOL aerial vehicle 100 via a communications network 105. The communications network 105 may be as previously described. The central server system 103 is configured to process vehicle data provided to the central server system 103 by the manned VTOL aerial vehicle 100. The central server system 103 is also configured to provide central server data to the manned VTOL aerial vehicle 100.

The central server system 103 may comprise a database 133. Alternatively, the central server system 103 may be in communication with the database 133 (e.g. via a network such as the communications network 105). The database 133 may therefore be a cloud-based database. The central server system 103 is configured to store the vehicle data in the database 133. The central server system 103 is configured to store the central server data in the database 133.

For example, the manned VTOL aerial vehicle 100 may be configured and/or operable to fly around a track. The track may be, or may form part of, the region described herein. The central server system 103 may be configured to communicate information regarding the track to the manned VTOL aerial vehicle 100.

The aerial vehicle system 101 may also comprise a trackside repeater 107. The trackside repeater 107 is configured to repeat wireless signals generated by the manned VTOL aerial vehicle 100 and/or the central server system 103 so that the manned VTOL aerial vehicle 100 and the central server system 103 can communicate at further distances than would be enabled without the trackside repeater 107. In some embodiments, the aerial vehicle system 100 comprises a plurality of trackside repeaters 107.

The aerial vehicle system 101 comprises an external sensing system 199. The external sensing system 199 is configured to generate external sensing system data. The external sensing system data may relate to one or more of the manned VTOL aerial vehicle 100 and the region within which the manned VTOL aerial vehicle 100 is located. The external sensing system 199 comprises an external sensing system imaging system 197. The external sensing system imaging system 197 is configured to generate external sensing system image data. For example, the external sensing system imaging system 197 may comprise one or more of an external LIDAR system configured to generate external LIDAR data, an external RADAR system configured to generate external RADAR data and an external visible spectrum imaging system configured to generate external visible spectrum image data.

The external sensing system 199 is configured to generate the external sensing system data based at least in part on inputs received by the external sensing system imaging system 197. For example, the external sensing system 199 is configured to generate point cloud data. This may be referred to as additional point cloud data, as it is additional to the point cloud data generated by the manned VTOL aerial vehicle 100 itself.

The external sensing system 199 is configured to provide the external sensing system data to the central server system 103 and/or the manned VTOL aerial vehicle 100 via the communications network 105 (and the trackside repeater 107 where necessary). The external sensing system 199 may comprise an external sensing system communication system (not shown). The external sensing system communication system may enable the external sensing system 199 to communicate with the central server system 103 and/or the manned VTOL aerial vehicle 100 (e.g. via the communications network 105). Therefore, the external sensing system communication system may enable the external sensing system 199 to provide the external sensing system data to the central server system 103 and/or the manned VTOL aerial vehicle 100.

In some embodiments, the external sensing system 199 may be considered part of the central server system 103. In some embodiments, the central server system 103 may provide the external sensing system data to the manned VTOL aerial vehicle 100 (e.g. via the communications network 105).

In some embodiments, the at least one processor 132 is configured to receive the external LIDAR data, the external RADAR data and the external visible spectrum imaging data. The external LIDAR data may comprise an external region point cloud representing the region.

The aerial vehicle system 101 also comprises one or more other aircraft 109. The other aircraft 109 may be configured to communicate with the manned VTOL aerial vehicle 100 via the communications network 105 and/or the trackside repeater 107. For example, the aerial vehicle system 101 may also comprise a spectator drone 111. The spectator drone 111 may be configured to communicate with the manned VTOL aerial vehicle 100 via the communications network 105 and/or the trackside repeater 107.

In some embodiments, the spectator drone 111 is configured to generate additional image data. The additional image data may comprise additional three-dimensional data. For example, the spectator drone 111 may comprise a LIDAR system and/or another imaging system capable of generating the additional three-dimensional data. The additional three-dimensional data may be in the form of one or more of a point cloud (i.e. it may be point cloud data) and a depth map (i.e. it may be depth map data). In some embodiments, the additional image data comprises one or more of the additional three-dimensional data, additional visible spectrum image data, additional LIDAR data, additional RADAR data and additional infra-red image data. The spectator drone 111 is configured to provide the additional image data to the central server system 103. The spectator drone 111 may provide the additional image data directly to the central server system 103 using the communications network 105. Alternatively, the spectator drone 111 may provide the additional image data to the central server system 103 via one or more of the trackside repeaters 107. The central server system 103 is configured to store the additional image data in the database 133.

In some embodiments, the spectator drone 111 is configured to be a trackside repeater. Therefore, the manned VTOL aerial vehicle 100 may communicate with the central server system 103 via the spectator drone 111. As such, the spectator drone 111 may be considered to be a communications relay or a communications backup (e.g. if one of the trackside repeaters 107 fails).

The aerial vehicle system 101 comprises a region mapping system 290. The region mapping system 290 is configured to generate region mapping system data. The region mapping system 290 is configured to generate a three-dimensional model of the region, based on the region mapping system data. The region mapping system 290 may comprise one or more of a region mapping camera system configured to generate visible spectrum region data, a region mapping LIDAR system configured to generate LIDAR region data and a region mapping RADAR system configured to generate RADAR region data. The region mapping system data comprises one or more of the visible spectrum region data, the LIDAR region data and the RADAR region data.

The region mapping system 290 (e.g. at least one region mapping system processor) is configured to determine the three-dimensional model of the region based at least in part on the region mapping system data (e.g. the visible spectrum region data, the LIDAR region data and the RADAR region data). In some embodiments, the region mapping system 290 is configured to process the visible spectrum region data to generate a region depth map. In some embodiments, the region mapping system 290 is configured to process the LIDAR data to determine an initial region point cloud.

The region mapping system 290 generates a three-dimensional occupancy grid based at least in part on the region mapping system data. For example, the region mapping system 290 determines the three-dimensional occupancy grid based at least in part on the region depth map and/or the initial region point cloud. The three-dimensional occupancy grid comprises a plurality of voxels. Each voxel is associated with a voxel probability that is indicative of a probability that a corresponding point of the region comprises an object and/or surface.

The three-dimensional occupancy grid may be an Octomap. In some embodiments, the region mapping system 290 generates the three-dimensional occupancy grid as is described in “OctoMap: An efficient probabilistic 3D mapping framework based on octrees”, Hornung, Armin & Wurm, Kai & Bennewitz, Maren & Stachniss, Cyrill & Burgard, Wolfram, (2013), Autonomous Robots. 34. 10.1007/s10514-012-9321-0 the content of which is incorporated by reference in its entirety.

The region mapping system 290 is configured to provide the three-dimensional model of the region to the manned VTOL aerial vehicle 100 and/or the central server system 103.

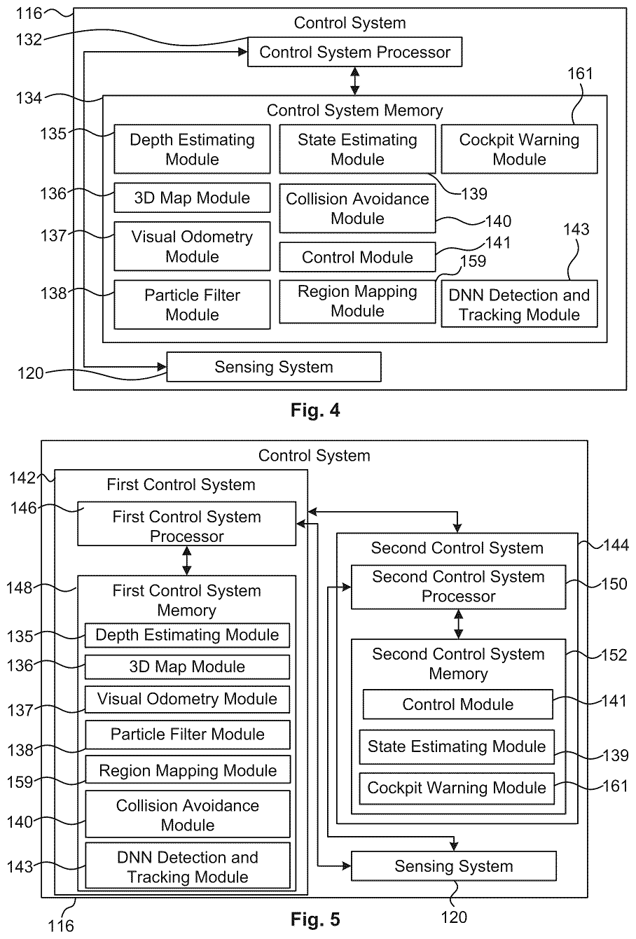

FIG. 4 is a block diagram of the control system 116, according to some embodiments. The control system 116 comprises at least one processor 132. The at least one processor 132 is configured to be in communication with memory 134. As previously described, the control system 116 comprises the sensing system 120. The sensing system 120 is configured to communicate with the at least one processor 132. In some embodiments, the sensing system 120 is configured to provide the sensor data to the at least one processor 132. In some embodiments, the at least one processor 132 is configured to receive the sensor data from the sensing system 120. In some embodiments, the at least one processor 132 is configured to retrieve the sensor data from the sensing system 120. The at least one processor 132 is configured to store the sensor data in the memory 134.

The at least one processor 132 is configured to execute program instructions stored in memory 134 to cause the control system 116 to function as described herein. In particular, the at least one processor 132 is configured to execute the program instructions to cause the manned VTOL aerial vehicle 100 to function as described herein. In other words, the program instructions are accessible by the at least one processor 132, and are configured to cause the at least one processor 132 to function as described herein. In some embodiments, the program instructions may be referred to as control system program instructions.

In some embodiments, the program instructions are in the form of program code. The at least one processor 132 comprises one or more microprocessors, central processing units (CPUs), application specific instruction set processors (ASIPs), application specific integrated circuits (ASICs), graphics processing units (GPUs), tensor processing units (TPUs), field-programmable gate arrays (FPGAs) or other processors capable of reading and executing program code. The program instructions comprise a depth estimating module 135, a three-dimensional map module 136, a visual odometry module 137, a particle filter module 138, a region mapping module 159, a state estimating module 139, a collision avoidance module 140, a cockpit warning module 161, a DNN detection and tracking module 143, and a control module 141.

Memory 134 may comprise one or more volatile or non-volatile memory types. For example, memory 134 may comprise one or more of random access memory (RAM), read-only memory (ROM), electrically erasable programmable read-only memory (EEPROM) or flash memory. Memory 134 is configured to store program code accessible by the at least one processor 132. The program code may comprise executable program code modules. In other words, memory 134 is configured to store executable code modules configured to be executable by the at least one processor 132. The executable code modules, when executed by the at least one processor 132 cause the at least one processor 132 to perform certain functionality, as described herein. In the illustrated embodiment, the depth estimating module 135, the three-dimensional map module 136, the visual odometry module 137, the particle filter module 138, region mapping module 159, the a cockpit warning module 161, the state estimating module 139, the collision avoidance module 140, the DNN detection and tracking module 143, and the control module 141 are in the form of program code stored in the memory 134.

The depth estimating module 135, the three-dimensional map module 136, the visual odometry module 137, the particle filter module 138, the state estimating module 139, the region mapping module 159, the cockpit warning module 161, the collision avoidance module 140, the DNN detection and tracking module 143, and/or the control module 141 are to be understood to be one or more software programs. They may, for example, be represented by one or more functions in a programming language, such as C++, C, Python or Java. The resulting source code may be compiled and stored as computer executable instructions on memory 134 that are in the form of the relevant executable code module.

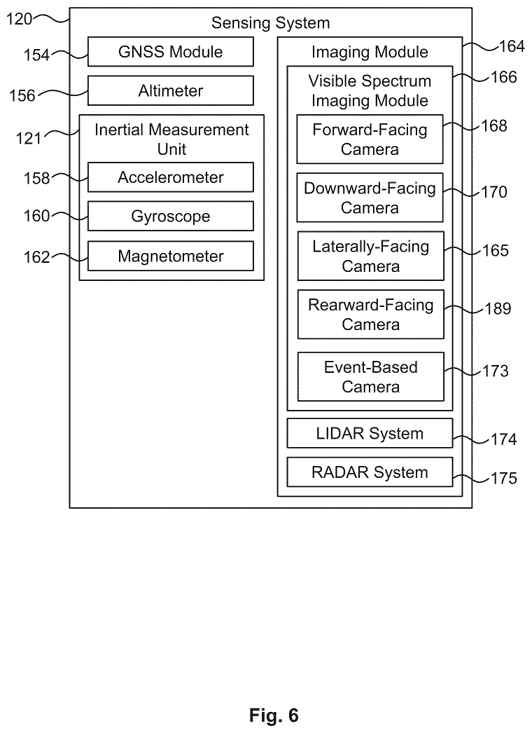

FIG. 6 is a block diagram of the sensing system 120, according to some embodiments. The sensing system 120 comprises a Global Navigation Satellite System (GNSS) module 154. The GNSS module 154 may comprise or be in the form of a GNSS real time kinetics (RTK) sensor. The GNSS module 154 may be configured to receive a Differential GNSS RTK correction signal from a fixed reference ground station. The reference ground station may be a GNSS reference ground station. This may be, for example, via the communications network 105, or another communications network.

The GNSS module 154 is configured to generate GNSS data. The GNSS data is indicative of one or more of a latitude, a longitude and an altitude of the manned VTOL aerial vehicle 100. The GNSS data may be in the form of a GNSS data vector that is indicative of the latitude, longitude and/or altitude of the manned VTOL aerial vehicle 100 at a particular point in time. Alternatively, the GNSS data may comprise GNSS time-series data. The GNSS time-series data can be indicative of the latitude, longitude and/or altitude of the manned VTOL aerial vehicle 100 over a time window. The GNSS time-series data can include GNSS data vectors that are sampled at a particular GNSS time frequency. The GNSS data may include a GNSS uncertainty metric that is indicative of an uncertainty of the relevant GNSS data.

The GNSS module 154 may be configured to utilise a plurality of GNSS constellations. For example, the GNSS module may be configured to utilise one or more of a Global Positioning System (GPS), a Global Navigation Satellite System (GLONASS), a BeiDou Navigation Satellite System (BDS), a Galileo system, a Quasi-Zenith Satellite System (QZSS) and an Indian Regional Navigation Satellite System (IRNSS or NavIC). In some embodiments, the GNSS module 154 is configured to utilise a plurality of GNSS frequencies simultaneously. In some embodiments, the GNSS module 154 is configured to utilise a plurality of GNSS constellations simultaneously.

The GNSS module 154 is configured to provide the GNSS data to the control system 116. In some embodiments, the GNSS module 154 is configured to provide the GNSS data to the at least one processor 132. The GNSS module 154 is configured to provide the GNSS data to the at least one processor 132. The sensor data comprises the GNSS data.

The sensing system 120 comprises an altimeter 156. The altimeter 156 is configured to generate altitude data. The altitude data is indicative of an altitude of the manned VTOL aerial vehicle 100. The altimeter 156 may comprise a barometer. The barometer may be configured to determine an altitude estimate above a reference altitude. The reference altitude may be an altitude threshold. The altimeter 156 may comprise a radar altimeter 163. The radar altimeter 163 is configured to determine an estimate of an above-ground altitude. That is, the radar altimeter 163 is configured to determine an estimate of a distance between the manned VTOL aerial vehicle 100 and the ground. The altimeter 156 is configured to provide the altitude data to the control system 116. In some embodiments, the altimeter 156 is configured to provide the altitude data to the at least one processor 132. The sensor data comprises the altitude data.

The sensing system 120 comprises an inertial measurement unit 121. The inertial measurement unit 121 comprises an accelerometer 158. The accelerometer 158 is configured to generate accelerometer data. The accelerometer data is indicative of an acceleration of the manned VTOL aerial vehicle 100. The accelerometer data is indicative of acceleration in one or more of a first acceleration direction, a second acceleration direction and a third acceleration direction. The first acceleration direction, second acceleration direction and third acceleration direction may be orthogonal with respect to each other. The accelerometer 158 is configured to provide the accelerometer data to the control system 116. In some embodiments, the accelerometer 158 is configured to provide the accelerometer data to the at least one processor 132. The sensor data comprises the accelerometer data.

The inertial measurement unit 121 comprises a gyroscope 160. The gyroscope 160 is configured to generate gyroscopic data. The gyroscopic data is indicative of an orientation of the manned VTOL aerial vehicle 100. The gyroscope 160 is configured to provide the gyroscopic data to the control system 116. In some embodiments, the gyroscope 160 is configured to provide the gyroscopic data to the at least one processor 132. The sensor data comprises the gyroscopic data.

The inertial measurement unit 121 comprises a magnetometer sensor 162. The magnetometer sensor 162 is configured to generate magnetic field data. The magnetic field data is indicative of an azimuth orientation of the manned VTOL aerial vehicle 100. The magnetometer sensor 162 is configured to provide the magnetic field data to the control system 116. In some embodiments, the magnetometer sensor 162 is configured to provide the magnetic field data to the at least one processor 132. The sensor data comprises the magnetic field data.

The sensing system comprises an imaging module 164. The imaging module 164 is configured to generate image data. In particular, the imaging module 164 is configured to generate image data that is associate with the region around the manned VTOL aerial vehicle 100. The imaging module 164 is configured to provide the image data to the control system 116. In some embodiments, the imaging module 164 is configured to provide the image data to the at least one processor 132. The sensor data comprises the image data.

The imaging module 164 comprises a visible spectrum imaging module 166. The visible spectrum imaging module 166 is configured to generate visible spectrum image data that is associated with the region around the manned VTOL aerial vehicle 100. The visible spectrum imaging module 166 is configured to provide the visible spectrum image data to the control system 116. In some embodiments, the visible spectrum imaging module 166 is configured to provide the visible spectrum image data to the at least one processor 132. The image data comprises the visible spectrum image data.

The visible spectrum imaging module 166 comprises a plurality of visible spectrum cameras 167. The visible spectrum cameras 167 are distributed across the body 102 of the manned VTOL aerial vehicle 100. The image data comprises visible spectrum image data. The image data comprises the optical flow data.

The visible spectrum imaging module 166 comprises a forward-facing camera 168. The forward-facing camera 168 is configured to generate image data that is associated with a portion of the region visible in front of a front portion 115 of the manned VTOL aerial vehicle 100. The forward-facing camera 168 is configured to be mounted to the manned VTOL aerial vehicle 100. In some embodiments, the visible spectrum imaging module 166 comprises a plurality of forward-facing cameras 168. Each forward-facing camera 168 may have different (but possibly overlapping) fields of view to capture images of different regions visible in front of the front portion 115 of the manned VTOL aerial vehicle 100.

The visible spectrum imaging module 166 also comprises a downward-facing camera 170. The downward-facing camera 170 is configured to generate image data that is associated with a portion of the region visible below the manned VTOL aerial vehicle 100. The downward-facing camera 170 is configured to be mounted to the manned VTOL aerial vehicle 100. In some embodiments, the visible spectrum imaging module 166 comprises a plurality of downward-facing cameras 170. Each downward-facing camera 170 may have different (but possibly overlapping) fields of view to capture images of different regions visible below the body 102 of the manned VTOL aerial vehicle 100. The downward-facing camera 170 may be referred to as a ground-facing camera.

The visible spectrum imaging module 166 comprises a laterally-facing camera 165. The laterally-facing camera 165 is configured to generate image data that is associated with a portion of the region visible to a side of the manned VTOL aerial vehicle 100. The laterally-facing camera 165 is configured to be mounted to the manned VTOL aerial vehicle 100. In some embodiments, the visible spectrum imaging module 116 may comprise a plurality of laterally-facing cameras 165. Each laterally-facing camera 165 may have different (but possibly overlapping) fields of view to capture images of different regions visible laterally of the body 102 of the manned VTOL aerial vehicle 100.

The visible spectrum imaging module 166 comprises a rearward-facing camera 189. The rearward-facing camera 189 is configured to generate image data that is associated with a portion of the region visible behind the manned VTOL aerial vehicle 100. The rearward-facing camera 189 is configured to be mounted to the manned VTOL aerial vehicle 100. In some embodiments, the visible spectrum imaging module 116 may comprise a plurality of rearward-facing cameras 189. Each rearward-facing camera 189 may have different (but possibly overlapping) fields of view to capture images of different regions visible behind the body 102 of the manned VTOL aerial vehicle 100.

The visible spectrum imaging module 166 comprises an event-based camera 173. The event-based camera 173 may be as described in “Event-based Vision: A Survey”, G. Gallego et al., (2020), IEEE Transactions on Pattern Analysis and Machine Intelligence, doi: 10.1109/TPAMI.2020.3008413, the content of which is incorporated herein by reference in its entirety.

The at least one processor 132 may execute the described visual odometry using the event-based camera 173. The at least one processor 132 may execute visual odometry as described in “Real-time Visual-Inertial Odometry for Event Cameras using Keyframe-based Nonlinear Optimization”, Rebecq, Henri & Horstschaefer, Timo & Scaramuzza, Davide, (2017), 10.5244/C.31.16, the content of which is incorporated herein by reference in its entirety.

The imaging module 164 comprises a Light Detection and Ranging (LIDAR) system 174. The LIDAR system 174 is configured to generate LIDAR data associated with at least a portion of the region around the manned VTOL aerial vehicle 100. The image data comprises the LIDAR data. The LIDAR system 174 comprises a LIDAR scanner 177. In particular, the LIDAR system 174 comprises a plurality of LIDAR scanners 177. The LIDAR scanners 177 may be distributed across the body 102 of the manned VTOL aerial vehicle 100. The LIDAR system 174 comprises a solid-state scanning LIDAR sensor 169. The LIDAR system 174 comprises a one-dimensional LIDAR sensor 171, such as a time-of-flight flash LIDAR sensor. The one-dimensional LIDAR sensor 171 may be in the form of a non-scanning LIDAR sensor.

The imaging module 164 comprises a Radio Detecting and Ranging (RADAR) system 175. The RADAR system 175 is configured to generate RADAR data associated with at least a portion of the region around the manned VTOL aerial vehicle 100. The image data comprises the RADAR data. The RADAR system 175 comprises a RADAR sensor 179. In particular, the RADAR system 175 comprises a plurality of RADAR sensors 179. The RADAR system 175 comprises a radar altimeter 163. The RADAR sensor 179 may be distributed across the body 102 of the manned VTOL aerial vehicle 100.

The RADAR system 175 is configured to generate a range-doppler map. The range-doppler map may be indicative of a position and a speed of the object 113. The sensor data may comprise one or more of the range-doppler map.

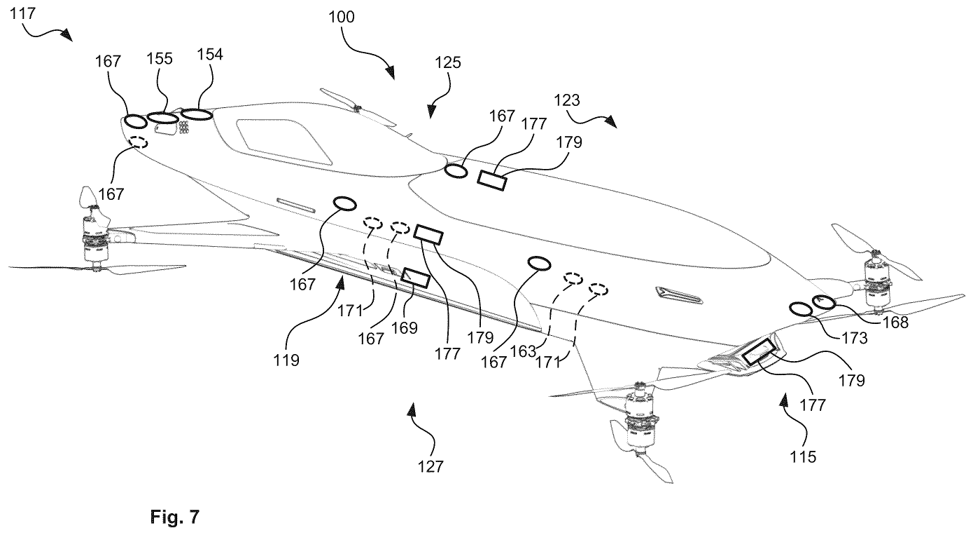

FIG. 7 is a perspective view of the manned VTOL aerial vehicle showing example positioning of a plurality of components of the sensing system 120, according to some embodiments. The manned VTOL aerial vehicle 100 comprises a front portion 115. The manned VTOL aerial vehicle 100 comprises a rear portion 117. The manned VTOL aerial vehicle 100 comprises a first lateral portion 119. The manned VTOL aerial vehicle 100 comprises a second lateral portion 123. The manned VTOL aerial vehicle 100 comprises an upper portion 125. The manned VTOL aerial vehicle 100 comprises a lower portion 127.

The rear portion 117 comprises a plurality of sensors. The sensors may be part of the sensing system 120. For example, as illustrated in FIG. 7, the rear portion 117 comprises a plurality of visible spectrum cameras 167. The rear portion 117 may comprise a rearward-facing camera (e.g. a rearward-facing visible spectrum camera). Alternatively, the rear portion 117 may comprise the downward-facing camera 170. The rear portion 117 comprises the network interface 155. The rear portion comprises the GNSS module 154.

The front portion 115 comprises a plurality of sensors. The sensors may be part of the sensing system 120. For example, as illustrated in FIG. 7, the front portion 115 comprises a visible spectrum camera 167. Specifically, the front portion 115 comprises the forward-facing camera 168. The front portion 115 comprises the event-based camera 173. In some embodiments, the event-based camera 173 comprises the forward-facing camera 168. The front portion 115 comprises a LIDAR scanner 177. The front portion 115 comprise a RADAR sensor 179.

The first lateral portion 119 may be a right-side portion of the manned VTOL aerial vehicle 100. The first lateral portion 119 comprises a visible spectrum camera 167. Specifically, first lateral portion 119 comprises a plurality of visible spectrum cameras 167. One or more of these may be the laterally facing camera 165 previously described. The first lateral portion 119 comprises a solid state scanning LIDAR sensor 169. The first lateral portion 119 comprises a LIDAR scanner 177. The first lateral portion 119 comprises a RADAR sensor 179.

The second lateral portion 123 may be a left-side portion of the manned VTOL aerial vehicle 100. The second lateral portion 123 may comprise the same or similar sensors as the first lateral portion 119.

The upper portion 125 comprises a plurality of sensors. The sensors may be part of the sensing system 120. The upper portion 125 comprises a visible spectrum camera 167. The upper portion 125 comprises a LIDAR scanner 177. The upper portion 125 comprises a RADAR sensor 179.

The lower portion 127 comprises a plurality of sensors. The sensors may be part of the sensing system 120. The lower portion comprises a visible spectrum camera 167. The visible spectrum camera 167 of the lower portion may assist with landing area monitoring and speed estimation using optical flow. The lower portion comprises the flash LIDAR sensor 171. The lower portion comprises a radar altimeter 163. The radar altimeter 163 may assist with vertical terrain monitoring. The lower portion comprises a one-dimensional LIDAR sensor (not shown). The one-dimensional LIDAR sensor may assist with landing the manned VTOL aerial vehicle 100. The lower portion 127 may also house the power source 130. For example, where the power source 130 comprises one or more batteries, the one or more batteries may be housed in the lower portion 127.

### Computer-Implemented Method for Controlling a Manned VTOL Aerial Vehicle

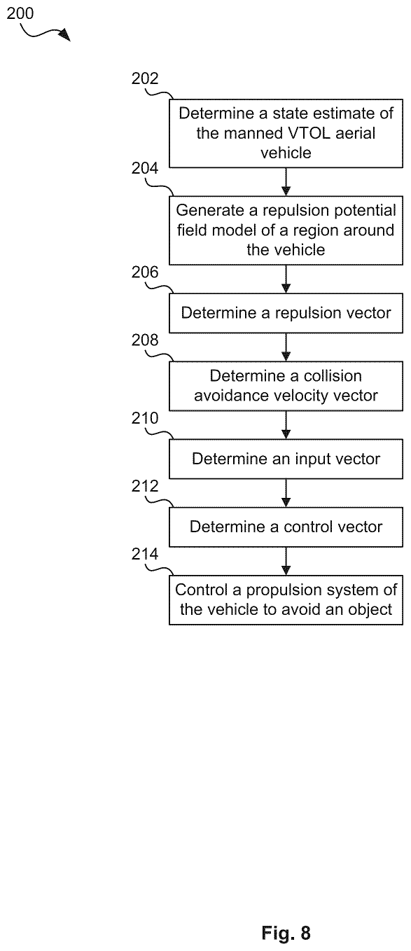

FIG. 8 is a process flow diagram illustrating a computer-implemented method 200 for controlling the manned VTOL aerial vehicle 100, according to some embodiments. The computer-implemented method 200 is performed by the control system 116. In some embodiments, the computer-implemented method 200 is performed by the at least one processor 132.

FIG. 8 is to be understood as a blueprint for one or more software programs and may be implemented step-by-step, such that each step in FIG. 8 may, for example, be represented by a function in a programming language, such as C++, C, Python or Java. The resulting source code is then compiled and stored as computer executable instructions on memory 134.

At 202, the at least one processor 132 determines a state estimate. The state estimate is indicative of a state of the manned VTOL aerial vehicle 100 within a region around the manned VTOL aerial vehicle 100. The state estimate is indicative of the state of the manned VTOL aerial vehicle 100 at a particular time. In some embodiments, the state of the manned VTOL aerial vehicle 100 may be indicative of a position of the manned VTOL aerial vehicle 100, an attitude of the manned VTOL aerial vehicle 100 and a velocity of the manned VTOL aerial vehicle 100.

The state of the manned VTOL aerial vehicle 100 may be indicative of a position of the manned VTOL aerial vehicle 100 within the region. The state estimate comprises a position estimate. The position estimate is indicative of the position of the manned VTOL aerial vehicle 100 within the region. The position estimate may comprise coordinates that are indicative of a three-dimensional position of the manned VTOL aerial vehicle 100 within the region (e.g. with respect to a fixed reference frame of the region).

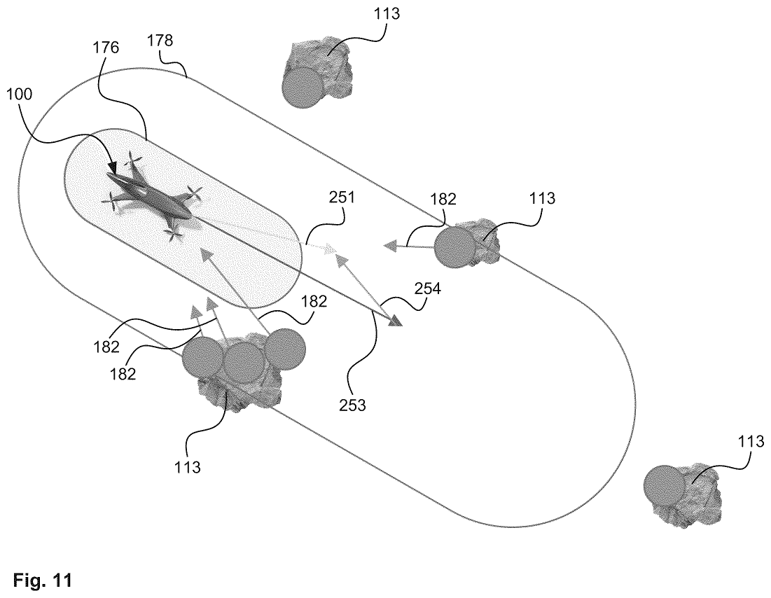

The state of the manned VTOL aerial vehicle 100 may be indicative of a velocity of the manned VTOL aerial vehicle 100. The state estimate comprises a speed vector 253 (FIG. 11). The speed vector 253 is indicative of the velocity of the manned VTOL aerial vehicle 100. The velocity may comprise a velocity magnitude and a velocity direction. The velocity direction may comprise coordinates that are indicative of a direction in which the manned VTOL aerial vehicle is travelling. The velocity magnitude may be referred to as a speed.

The state of the manned VTOL aerial vehicle 100 may be indicative of an attitude of the manned VTOL aerial vehicle 100. The state estimate comprises an attitude vector. The attitude vector is indicative of the attitude of the manned VTOL aerial vehicle 100.

The at least one processor 132 determines the position estimate that is indicative of the position of the manned VTOL aerial vehicle 100. In some embodiments, the at least one processor 132 determines the position estimate based at least in part on the GNSS data. The at least one processor 132 may receive the GNSS data from the GNSS module 154. In other words, the at least one processor 132 may determine the GNSS data. The GNSS data may be indicative of a latitude, a longitude and/or an altitude of the manned VTOL aerial vehicle 100. The position estimate may therefore comprise reference to, or be indicative of one or more of the latitude, longitude and altitude. Thus, the at least one processor 132 determines the state estimate based at least in part on the GNSS data.

In some embodiments, the at least one processor 132 determines the position estimate based at least in part on one or more of the LIDAR data, the visible spectrum image data and the RADAR data. Thus, the at least one processor 132 may determine the state estimate based at least in part on one or more of the LIDAR data, the visible spectrum image data and the RADAR data.

The at least one processor 132 determines the speed vector 253 that is indicative of a velocity of the manned VTOL aerial vehicle 100. The at least one processor 132 may determine the speed vector 253 based at least in part on one or more of the accelerometer data, the gyroscopic data, the magnetic field data and the image data that is associated with the region. In other words, the at least one processor 132 may determine the state estimate based at least in part on one or more of the altitude data, the accelerometer data, the gyroscopic data, the magnetic field data, and the image data.

In some embodiments, the at least one processor 132 determines the speed vector 253 based at least in part on one or more of the LIDAR data, the visible spectrum image data and the RADAR data. Thus, the at least one processor 132 may determine the state estimate based at least in part on one or more of the LIDAR data, the visible spectrum image data and the RADAR data. In other words, the at least one processor 132 may determine the speed vector 253 based at least in part on the image data.

The at least one processor 132 determines the attitude vector that is indicative of the attitude of the manned VTOL aerial vehicle 100. In some embodiments, the at least one processor 132 determines the attitude vector based at least in part on one or more of the gyroscopic data, the accelerometer data and the magnetic field data. Thus, the at least one processor 132 may determine the state estimate based at least in part on one or more of the gyroscopic data, the accelerometer data and the magnetic field data.

In some embodiments, the at least one processor 132 determines the attitude vector based at least in part on one or more of the LIDAR data, the visible spectrum image data and the RADAR data. Thus, the at least one processor 132 may determine the state estimate based at least in part on one or more of the LIDAR data, the visible spectrum image data and the RADAR data. In other words, the at least one processor 132 may determine the attitude vector based at least in part on the image data.

In some embodiments, the at least one processor 132 determines the state estimate using visual odometry. The state estimate is a complementary position, attitude estimate and/or velocity estimate. The at least one processor 132 determines a longitudinal velocity estimate that is indicative of a longitudinal velocity of the manned VTOL aerial vehicle 100. The longitudinal velocity estimate comprises a first longitudinal velocity component (V_{y}) and a second longitudinal velocity component (V_{y}). The at least one processor 132 determines the longitudinal velocity estimate based at least in part on the image data captured by the ground-facing camera 170. The at least one processor 132 determines an acceleration estimate that is indicative of an acceleration of the manned VTOL aerial vehicle 100, based at least in part on the accelerometer data provided by the accelerometer 158. The at least one processor 132 determines an orientation estimate that is indicative of an orientation of the manned VTOL aerial vehicle 100, based at least in part on the gyroscopic data provided by the gyroscope 160. The at least one processor 132 determines an altitude estimate that is indicative of an altitude of the manned VTOL aerial vehicle 100, based at least in part on the altitude data provided by the altimeter 156. The at least one processor 132 determines an azimuth orientation estimate of the manned VTOL aerial vehicle 100, based at least in part on the magnetic field data provided by the magnetometer sensor 162. The at least one processor 132 determines the state estimate based at least in part on the longitudinal velocity estimate. The at least one processor 132 determines the state estimate based at least in part on one or more of the acceleration estimate, the orientation estimate, the azimuth orientation estimate and optionally also the altitude estimate. In some embodiments, the at least one processor 132 determines the position estimate based at least in part on the longitudinal velocity estimate. In some embodiments, the at least one processor 132 determines the speed vector 253 based at least in part on the longitudinal velocity estimate.

In some embodiments, the at least one processor 132 determines the position estimate and/or the velocity estimate using optical flow calculations as is described in “An open source and open hardware embedded metric optical flow CMOS camera for indoor and outdoor applications”, Honegger, Dominik & Meier, Lorenz & Tanskanen, Petri & Pollefeys, Marc, (2013), Proceedings-IEEE International Conference on Robotics and Automation. 1736-1741. 10.1109/ICRA.2013.6630805, the content of which is incorporated by reference in its entirety.

In some embodiments, the at least one processor 132 determines the state estimate based at least in part on an egomotion estimate. The egomotion estimate comprises an estimated translation vector. The estimated translation vector is indicated of an estimated translation of the manned VTOL aerial vehicle 100 between a first time and a second time. The egomotion estimate comprises a rotation matrix. The rotation matrix is indicative of a rotation of the manned VTOL aerial vehicle 100 between the first time and the second time. The at least one processor 132 may execute the visual odometry module 137 to determine the egomotion estimate.

The first time may be referred to as an initial time. Time (e.g. the first time or the second time disclosed herein), when used in this disclosure, may correspond to a time, when measured using a reference clock (e.g. Greenwich Mean Time). That is, the time may correspond to a point in time. Alternatively, the time may be a reference time indicated by a time stamp. For example, the sensor data at a particular point in time may comprise, or be appended with a time stamp associated with the particular point in time. The time may correspond to the time stamp of the relevant sensor data. Alternatively, the time may correspond to a point defined by the time stamp. The time stamp may correspond to a reference time measured using a reference clock (e.g. Greenwich Mean Time). Alternatively, the time stamp may correspond to an internal time. For example, the time stamp may correspond to a count maintained by the at least one processor 132.

The at least one processor 132 determines the egomotion estimate based at least in part on image data captured by the forward-facing camera 168 mounted on the manned VTOL aerial vehicle 100. The at least one processor 132 determines an acceleration estimate that is indicative of an acceleration of the manned VTOL aerial vehicle 100, based at least in part on the accelerometer data provided by the accelerometer 158. The at least one processor 132 determines an orientation estimate that is indicative of an orientation of the manned VTOL aerial vehicle 100, based at least in part on the gyroscopic data provided by the gyroscope 160. The at least one processor 132 determines altitude data that is indicative of the altitude of the manned VTOL aerial vehicle 100, based at least in part on the altitude data provided by the altimeter 156. The at least one processor 132 determines an azimuth orientation estimate of the manned VTOL aerial vehicle 100, based at least in part on the magnetic field data provided by the magnetometer sensor 162. The at least one processor 132 determines the state estimate based at least in part on one or more of the egomotion estimate, the acceleration estimate, the orientation estimate, the altitude estimate and the azimuth orientation estimate. In some embodiments, the first state estimation may rely on an extended Kalman filter, separate from the extended Kalman filter used for the third state estimation.

The at least one processor 132 determines a state estimate confidence metric. The state estimate confidence metric is indicative of an error associated with the state estimate. The state estimate confidence metric may be referred to as a vehicle state estimate confidence metric. The at least one processor 132 determines the state estimate confidence metric based at least in part on an error associated with the sensor data used to determine the state estimate (e.g. the visible spectrum image data, LIDAR data etc.). In some embodiments, the state estimate confidence metric is indicative of a degree of error associated with the state estimate. In some embodiments, the state estimate comprises the state estimate confidence metric.

The at least one processor 132 generates a three-dimensional point cloud representing the region. The at least one processor 132 may generate the three-dimensional point cloud based on one or more of the LIDAR data, RADAR data and visible spectrum image data, for example. Therefore, determining the state estimate may comprise generating the three-dimensional point cloud.

In some embodiments, the at least one processor 132 determines an initial state estimate that is indicative of an estimated initial state of the manned VTOL aerial vehicle 100. The at least one processor 132 compares the three-dimensional point cloud to a three-dimensional model of the region. The three-dimensional model of the region is stored in memory 134. The three-dimensional model of the region may have been pre-generated based on three-dimensional data (e.g. LIDAR data) of the region taken from another device (e.g. a ground-based LIDAR system). In some embodiments, the three-dimensional model of the region is the three-dimensional model of the region generated by the region mapping system 290. The at least one processor 132 determines an updated state estimate based at least in part on a result of the comparison. The state estimate corresponds to the updated state estimate.

In some embodiments, the at least one processor 132 determines an initial state estimate that is indicative of an estimated state of the manned VTOL aerial vehicle 100 at a first time. The at least one processor 132 determines an egomotion estimate, based at least in part on image data captured by the forward-facing camera 168. The egomotion estimate is indicative of movement of the manned VTOL aerial vehicle 100 between the first time and a second time. The at least one processor 132 determines an acceleration estimate that is indicative of an acceleration of the manned VTOL aerial vehicle 100 between the first time and a second time. The acceleration estimate may be determined based at least in part on the accelerometer data. The at least one processor 132 determines an orientation change estimate that is indicative of a change in orientation of the manned VTOL aerial vehicle 100 between the first time and the second time. The orientation change estimate may be determined based at least in part on the gyroscopic data. The at least one processor 132 determines an altitude change estimate that is indicative of a change in altitude of the manned VTOL aerial vehicle 100 between the first time and the second time. The altitude change estimate may be determined based at least in part on the altitude data. The at least one processor 132 determines an azimuth change estimate that is indicative of a change in the azimuth of the manned VTOL aerial vehicle 100 between the first time and the second time. The at least one processor 132 determines an updated position estimate based at least in part on the initial position estimate and one or more of the egomotion estimate, the acceleration estimate, the orientation change estimate, the azimuth change estimate and the altitude change estimate. The state estimate may correspond to the updated state estimate.

The at least one processor 132 executes at least the state estimating module 139 to determine the state estimate of the manned VTOL aerial vehicle 100.

At 204, the at least one processor 132 generates a repulsion potential field model of the region. The at least one processor 132 generates the repulsion potential field model of the region based at least in part on the sensor data. As illustrated in FIG. 3, the region comprises the object 113. The repulsion potential field model is associated with the object 113. In particular, the repulsion potential field model is associated with an object state estimate.

The at least one processor 132 determines a region state estimate. The region state estimate is indicative of a state of the region around the manned VTOL aerial vehicle. The at least one processor 132 determines the region state estimate based at least in part on the visible spectrum image data. The at least one processor 132 determines the region state estimate based at least in part on the external sensing system data. In some embodiments, the external sensing system data comprises the region state estimate. The at least one processor may execute the region mapping module 159 to determine the region state estimate.

The at least one processor 132 determines a region state estimate confidence metric. The region state estimate confidence metric is indicative of an error associated with the state estimate. The at least one processor 132 determines the region state estimate confidence metric based at least in part on an error associated with the sensor data used to determine the region state estimate (e.g. the visible spectrum image data).

The at least one processor 132 determines an object state estimate. The object state estimate is indicative of a position of the object 113. The at least one processor 132 determines the object state estimate based at least in part on the sensor data. The object state estimate is indicative of a velocity of the object 113. The object state estimate is indicative of an attitude of the object 113. The object state estimate comprises an object position estimate. The object position estimate is indicative of the position of the object 113 within the region. The object state estimate comprises an object speed vector. The object speed vector is indicative of the velocity of the object 113. The velocity of the object 113 may comprise an object velocity magnitude and an object velocity direction. The object velocity magnitude may be referred to as an object speed. The object state estimate comprises an object attitude vector. The object attitude vector is indicative of an attitude of the object 113. The at least one processor 132 determines the object state estimate using the three dimensional point cloud. Alternatively, the at least one processor 132 receives the object state estimate from another computing device (e.g. the central server system 103). In some embodiments, the external sensing system data comprises the object state estimate.

The object 113 may be a static object. That is, the object 113 may be static with respect to the region (or a fixed reference frame of the region). Further, the object 113 may be static with respect to a fixed reference frame of the repulsion potential field model. The object 113 may be a dynamic object. That is, the object 113 may be dynamic (or move) with respect to the region (or the fixed reference frame of the region) over time. Alternatively, the object 113 may be dynamic with respect to a fixed reference frame of the repulsion potential field model.

The object 113 may be a real object. That is, the object 113 may exist within the three-dimensional space of the region. For example, the object 113 may define a surface (such as the ground, a wall, a ceiling etc.) or an obstacle (such as another vehicle, a track marker, a tree or a bird). Alternatively, the object 113 may be a virtual object. For example, the object 113 may be defined only in the repulsive field model. For example, the object 113 may be a virtual surface (such as a virtual wall, a virtual ceiling etc.) or a virtual obstacle (such as a virtual vehicle, a virtual track marker, a virtual tree or a virtual bird).

Virtual objects can be useful for artificially constraining the region within which the manned VTOL aerial vehicle can fly. For example, the virtual object can be in the form of a three-dimensional virtual boundary. The manned VTOL aerial vehicle 100 may be authorised to fly within the three-dimensional virtual boundary (e.g. a race track), and unauthorised to fly outside the three-dimensional virtual boundary. The three-dimensional virtual boundary can form a complex three-dimensional flight path, allowing simulation of a technically challenging flight path. Thus, the virtual objects can be used for geofencing. Virtual objects can also be used for pilot training. For example, when the pilot trains to race the manned VTOL aerial vehicle 100, other vehicles against which the pilot can race can be simulated using virtual objects. This reduces the need to actually have other vehicles present, and improves the safety of the pilot, as the risk of the pilot crashing is reduced.

The at least one processor 132 determines an object state estimate confidence metric. The object state estimate confidence metric is indicative of an error associated with the object state estimate. The at least one processor 132 determines the object state estimate confidence metric based at least in part on an error associated with the sensor data used to determine the object state estimate (e.g. the visible spectrum image data). In some embodiments, the object state estimate confidence metric is indicative of a degree of error associated with the object state estimate. In some embodiments, the object state estimate comprises the object state estimate confidence metric.

The at least one processor 132 executes DNN detection and tracking module 143 to determine the object state estimate based at least in part on the visible spectrum image data. The visible spectrum image data is used as an input to a Deep Neural Network. The at least one processor 132 detects, localises and/or classifies the object 113 based at least in part on the visible spectrum image data.

The at least one processor 132 may perform image segmentation to detect, localise and/or classify the object 113. The image segmentation may be based on a pixel value threshold, edge detection, clustering or a convolutional neural network (CNN), for example.

The at least one processor 132 may use an artificial neural network (ANN) to detect, localise and/or classify the object 113. The ANN may be in the form of a CNN-based architecture that may include one or more of an input layer, convolutional layers, fully connected layers, pooling layers, binary step activation functions, linear activation functions and non-linear activation functions.

For example, the at least one processor 132 may use a neural network to detect, localise and/or classify the object 113 as described in “Detection of a Moving UAV Based on Deep Learning-Based Distance Estimation”, Lai, Ying-Chih & Huang, Zong-Ying, (2020), Remote Sensing, 12(18), 3035, the content of which is incorporated herein by reference in its entirety.

In some embodiments, the region comprises a plurality of objects 113. A first sub-set of the plurality of objects 113 may be dynamic objects. A second sub-set of the plurality of objects may be static objects.

Each object 113 is associated with a respective repulsion potential field function. The at least one processor 132 may generate the repulsion potential field model by summing the repulsion potential field functions.

In some embodiments, the at least one processor 132 determines the repulsion potential field model as is described in “Autonomous Collision Avoidance for a Teleoperated UAV Based on a Super-Ellipsoidal Potential Function”, Qasim, Mohammed Salim, (2016), University of Denver Electronic Theses and Dissertations, the content of which is incorporated herein by reference in its entirety. For example, the at least one processor 132 determines the repulsion potential field model using the potential function described in the above document.

In some embodiments, the at least one processor 132 determines the repulsion potential field model as is described in U.S. Pat. No. 5,006,988A, the content of which is incorporated herein by reference in its entirety.

Referring to FIG. 10, the at least one processor 132 defines a first software-defined virtual boundary 176. The first software-defined virtual boundary 176 is associated with the potential field model. The first software-defined virtual boundary 176 surrounds the position estimate. The first software-defined virtual boundary 176 may correspond to a minimised software-defined virtual boundary 176a. The minimised software-defined virtual boundary 176a is a software-defined virtual boundary that encircles the manned VTOL aerial vehicle 100 within the potential field model, minimising any excess size beyond an outer profile of the manned VTOL aerial vehicle. The first software-defined virtual boundary 176 may correspond to an intermediate software-defined virtual boundary 176b. The intermediate software-defined virtual boundary 176b may encircle the manned VTOL aerial vehicle 100 within the potential field model and additional space around the manned VTOL aerial vehicle 100. The additional space may provide a safety distance. The first software-defined virtual boundary 176 may be dimensioned to correspond to a minimum stopping distance of the manned VTOL aerial vehicle 100. The minimum stopping distance is the minimum distance manned VTOL aerial vehicle 100 requires to stop when under a maximum acceleration. The first software-defined virtual boundary 176 is a super-ellipsoid. The first software-defined virtual boundary 176 is a three-dimensional virtual boundary. The first software-defined virtual boundary 176 may be a first super-ellipsoid.

In some embodiments, the first software-defined virtual boundary 176 is aligned with the direction of motion of the manned VTOL aerial vehicle 100. In other words, the first super-ellipsoid is aligned with the direction of motion of the manned VTOL aerial vehicle 100. The first software-defined virtual boundary 176 may therefore define a major axis. The first software-defined virtual boundary 176 may define one or more minor axes. The major axis is aligned with the direction of motion of the manned VTOL aerial vehicle 100. In other words, the first software-defined virtual boundary 176, the first super-ellipsoid and/or the major axis are aligned with the speed vector.

The at least one processor 132 defines a second software-defined virtual boundary 178. The second software-defined virtual boundary 178 is associated with the potential field model. The second software-defined virtual boundary 178 surrounds the position estimate and the first software-defined virtual boundary 176. The second software-defined virtual boundary 178 is a super-ellipsoid. The second software-defined virtual boundary 178 is a three-dimensional virtual boundary. The second software-defined virtual boundary 178 may be a second super-ellipsoid.

In some embodiments, the second software-defined virtual boundary 178 is aligned with the direction of motion of the manned VTOL aerial vehicle 100. In other words, the second super-ellipsoid is aligned with the direction of motion of the manned VTOL aerial vehicle 100. The second software-defined virtual boundary 178 may therefore define a major axis. The second software-defined virtual boundary 178 may define one or more minor axes. The major axis is aligned with the direction of motion of the manned VTOL aerial vehicle 100. In other words, the second software-defined virtual boundary 178, the second super-ellipsoid and/or the major axis are aligned with the speed vector.

As previously described, each object 113 is associated with a respective repulsion potential field function and the at least one processor 132 generates the repulsion potential field model by summing the repulsion potential field functions. In other words, the repulsion potential field function is defined by defining the potential field function for each object.

In general terms, the potential field function associated to each object 113 may be, for example:

$${P}_{Srep} = \{ \begin{matrix}\begin{matrix}0 , if the object position estimate is \\ outside the first virtual boundary\end{matrix} \\ \begin{matrix}1 , if the object position estimate is \\ inside the first virtual boundary\end{matrix} \\ μ f ( {p}_{o} , {v}_{r} , {v}_{o} ) , otherwise\end{matrix} .$$

where P_{Srep} is the potential field function of the relevant object 113, μ is a scaling parameter configured to scale the potential field function, ƒ is a continuous function that satisfied boundary constraints, pₒ is the object's 113 position (i.e. the object position estimate of the object state estimate), vᵣ is the manned VTOL aerial vehicle's 100 velocity (i.e. the speed vector) and vₒ is the object's 113 velocity (i.e. the speed vector). This potential field function may be applicable for both static objects and dynamic objects.

The potential field function associated to each object 113 may be, for example:

$${P}_{Srep} = \{ \begin{matrix}\begin{matrix}0 , if the object position estimate is \\ outside the first virtual boundary\end{matrix} \\ \begin{matrix}1 , if the object position estimate is \\ inside the first virtual boundary\end{matrix} \\ {μ ( \frac{‖ {p}_{or} ‖ - {R}_{i} ( {v}_{r} )}{{R}_{0} - {R}_{i} ( {v}_{r} )} - 1 )}^{2} , otherwise\end{matrix} .$$

If the object is a static object, where P_{Srep} is the potential field function of the relevant object 113, μ is a scaling parameter configured to scale the potential field function, pᵣ is the manned VTOL aerial vehicle's 100 position (i.e. the position estimate of the state estimate), pₒ is the object's 113 position (i.e. the object position estimate of the object state estimate), Rᵢ is a first distance from the manned VTOL aerial vehicle 100 to the first software-defined virtual boundary 176 along a line that is collinear with the object position estimate, Rₒ is a second distance from the manned VTOL aerial vehicle 100 to the second software-defined virtual boundary 178 along a second line that is collinear with the object position estimate and vᵣ is the manned VTOL aerial vehicle's 100 velocity (i.e. the speed vector).

The first software-defined virtual boundary 176 may correspond to the inner super-ellipse of the above-mentioned reference. The second software-defined virtual boundary 178 may correspond to the outer super-ellipse of the above-mentioned reference.

Where there is a plurality of objects 113, generating the repulsion potential field model comprises determining an object repulsion potential field model for each object of the plurality of objects 113. The object potential field model of an object 113 may correspond to the potential field function of that object 113. That is, the at least one processor 132 determines an object repulsion potential field model for each object of the plurality of objects 113. The at least one processor 132 sums the object repulsion potential field models to generate the repulsion filed model.

Where there is a plurality of objects 113, the plurality of objects 113 may comprise a first object class that comprises a sub-set (e.g. a third sub-set) of the objects 113. The objects 113 of the first object class may comprise one or more similar characteristics. The plurality of objects 113 may also comprise a second object class that comprises a sub-set (e.g. a fourth sub-set) of the objects 113. The objects 113 of the second object class may comprise one or more similar characteristics. When determining the repulsion potential field model, the at least one processor 132 may use a first potential field function for objects 113 of the first object class. The at least one processor 132 may use a second potential field function for objects 113 of the second object class. The first potential field function may be different to the second potential field function. This may be because, for example, objects of the first object class are more dangerous to collide with than objects of the second object class.

At 206, the at least one processor 132 determines a repulsion vector. The at least one processor 132 may determine the repulsion vector based at least in part on the potential field model. The at least one processor 132 may determine the repulsion vector based at least in part on the state estimate. The at least one processor 132 may determine the repulsion vector based at least in part on the state estimate confidence metric. The repulsion vector is associated with the object 113 (or the plurality of objects 113, where applicable).

### Determining the Repulsion Vector Based at Least in Part on the Repulsion Potential Function(s)

Referring to FIG. 11, where there is a plurality of objects 113, the at least one processor 132 determines an object repulsion vector 182 for each object 113. The at least one processor 132 determines the object repulsion vector 182 for each object 113 using the object repulsion potential field model of the respective object 113. The at least one processor 132 determines the object repulsion vector 182 for each object 113 by determining the gradient of the respective repulsion potential function at the position estimate.

The at least one processor 132 determines a summed object repulsion vector. The summed object repulsion vector is a sum of the object repulsion vectors 182 of the static objects of the plurality of objects 113. The at least one processor 132 saturates a norm of the sum of the repulsion vectors 182 of the static objects to a maximum repulsion vector norm. To saturate the norm of the sum of the repulsion vectors 182 of the static objects to the maximum repulsion vector norm comprises, the at least one processor 132 determines a norm of the summed object repulsion vector. The at least one processor 132 determines a norm of each of the repulsion vectors 182. The at least one processor 132 compares the norms of each of the repulsion vectors 182 to determine the maximum repulsion vector norm. The at least one processor 132 saturates the summed object repulsion vector from the norm of the summed object repulsion vector to the maximum repulsion vector norm, thereby determining a saturated object repulsion vector.

The at least one processor 132 determines a dynamic object repulsion vector for each of the dynamic objects 113. The at least one processor 132 determines the dynamic object repulsion vectors by determining the gradient of the respective potential field function at the position estimate.

The at least one processor 132 sums the saturated object repulsion vector and the dynamic object repulsion vectors to determine the repulsion vector 254.

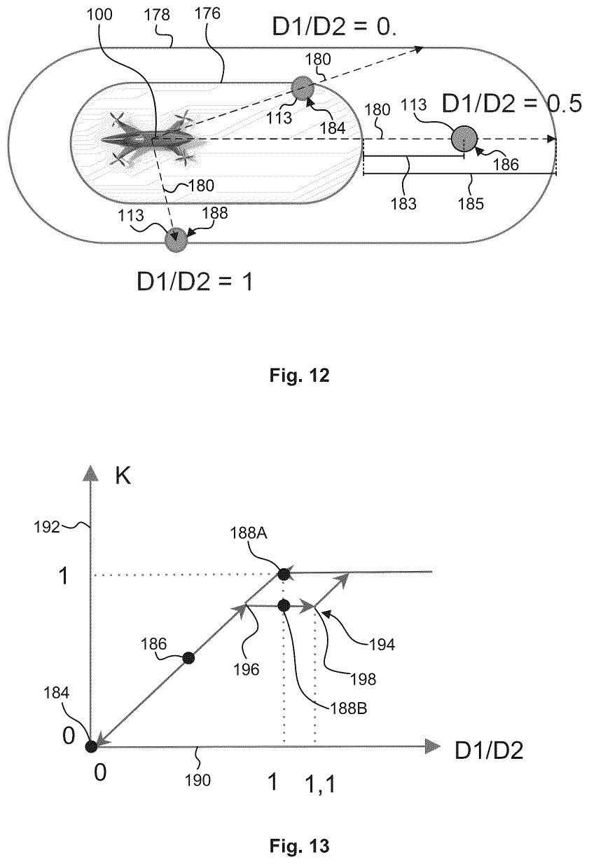

A magnitude of the repulsion vector 254 is based at least partially on a distance between the object position estimate and the first software-defined virtual boundary 176 in a measurement direction 180 (FIG. 12). The measurement direction 180 corresponds to a line that intersects both the position estimate and the object position estimate. The magnitude of the repulsion vector 254 is based at least partially on a distance between the object position estimate and the second software-defined virtual boundary 178 in the measurement direction 180.

The magnitude of the repulsion vector 254 is a maximum when the object position estimate is on or within the first software-defined virtual boundary 176. For example, the magnitude of the repulsion vector 254 may be 1 when the object position estimate is on or within the first software-defined virtual boundary 176. The magnitude of the repulsion vector 254 is a minimum when the object position estimate is outside the second software-defined virtual boundary 178. For example, the magnitude of the repulsion vector 254 may be 0 when the object position estimate is outside the second software-defined virtual boundary 178.

At 208, the at least one processor 132 determines a collision avoidance velocity vector. In particular, the at least one processor 132 determines the collision avoidance velocity vector based at least in part on the speed vector 253 and the repulsion vector 254. The collision avoidance velocity vector comprises a collision avoidance velocity vector magnitude and a collision avoidance velocity vector direction. The at least one processor 132 sums the speed vector 253 and the repulsion vector 254 to determine the collision avoidance velocity vector. The collision avoidance velocity vector is shown as collision avoidance velocity vector 251 in FIG. 11.

The at least one processor 132 determines the collision avoidance velocity vector 251 based at least in part on a sum of the repulsion vectors of the dynamic objects of the plurality of objects 113 and the saturated norm.

The collision avoidance velocity vector 251 described herein may comprise, or be determined as described with reference to the collision avoidance motion vectors described in the above document. That is, the collision avoidance velocity vector 251 described herein may comprise the collision avoidance motion vector for static objects:

$${V}_{Sca} = \{ \begin{matrix}\begin{matrix}0 , if the object position estimate is \\ outside the first virtual boundary\end{matrix} \\ \begin{matrix}- \overline{μ} {n}_{or} , if the object position estimate is \\ inside the first virtual boundary\end{matrix} \\ \overline{μ} ( \frac{‖ {p}_{or} ‖ - {R}_{i} ( {v}_{r} )}{{R}_{0} - {R}_{i} ( {v}_{r} )} - 1 ) {n}_{or} , otherwise\end{matrix} .$$

In this case, the continuous function ƒ described previously with relation to the potential field function

$${P}_{Srep} , is ( \frac{‖ {p}_{or} ‖ - {R}_{i} ( {v}_{r} )}{{R}_{0} - {R}_{i} ( {v}_{r} )} - 1 ) .$$

Further, the collision avoidance velocity vector 251 described herein may comprise the collision avoidance motion vector for dynamic objects:

$${V}_{Dca} = \{ \begin{matrix}\begin{matrix}0 , if the object position estimate is \\ outside the first virtual boundary\end{matrix} \\ \begin{matrix}- {\overline{μ}}_{1} {n}_{or} + {\overline{μ}}_{2} \frac{{v}_{rel} + {v}_{ro} {n}_{or}}{‖ {p}_{ro} ‖} , if the object position estimate is \\ inside the first virtual boundary\end{matrix} \\ {\overline{μ}}_{1} ρ {n}_{or} - {\overline{μ}}_{2} ρ \frac{{v}_{rel} + {v}_{ro} {n}_{or}}{‖ {p}_{ro} ‖} , otherwise\end{matrix} .$$

Where μ, μ̅₁ and μ̅₂ are as defined in “Autonomous Collision Avoidance for a Teleoperated UAV Based on a Super-Ellipsoidal Potential Function”, Qasim, Mohammed Salim, (2016), University of Denver Electronic Theses and Dissertations.

The at least one processor 132 executes the collision avoidance module 140 to determine the collision avoidance velocity vector 251.

At 210, the at least one processor 132 determines an input vector. The at least one processor 132 determines the input vector based at least in part on input received by the pilot-operable controls 118. The pilot may actuate the pilot-operable controls 118 to attempt to control the manned VTOL aerial vehicle 100. For example, the pilot may attempt to adjust the angular velocity of the manned VTOL aerial vehicle 100 and/or the thrust of the manned VTOL aerial vehicle 100 via the pilot-operable controls 118. The input vector is indicative of an intended angular velocity of the manned VTOL aerial vehicle 100 and an intended thrust of the manned VTOL aerial vehicle 100. The intended angular velocity reflects the pilot's intended angular velocity for the manned VTOL aerial vehicle 100. The intended thrust reflects the pilot's intended thrust for the manned VTOL aerial vehicle 100. The input vector may comprise a plurality of angular rate elements. The input vector may comprise an angular rate element for each of a plurality (e.g. three) axes. Each angular rate element may be associated with a respective one of a pitch, yaw and roll of the manned VTOL aerial vehicle 100.

At 212, the at least one processor 132 determines a control vector. In particular, the at least one processor 132 determines the control vector based at least in part on the collision avoidance velocity vector 251 and the input vector. To determine the control vector, the at least one processor 132 scales the input vector by a first scaling parameter to generate a scaled input vector. In some embodiments, the at least one processor 132 scales a derived input vector by the first scaling parameter to generate the scaled input vector. The derived input vector may be derived from the input vector. For example, the input vector may comprise angular rate inputs (roll, pitch and yaw inputs) and a thrust input. These inputs may be processed to determine the derived input vector.

To determine the control vector, the at least one processor 132 scales the collision avoidance velocity vector 251 by a second scaling parameter to generate a scaled collision avoidance velocity vector. In some embodiments, the at least one processor 132 scales a derived collision avoidance velocity vector by the second scaling parameter to generate a scaled collision avoidance velocity vector.

In other words, the collision avoidance velocity vector 251, input vector, derived input vector and/or derived collision avoidance velocity vector are weighted.

The at least one processor 132 adds the scaled input vector to the scaled collision avoidance velocity vector, thereby determining the control vector. The first scaling parameter and the second scaling parameter add to 1. The vectors used in the weighted sum are homogenous.

The first scaling parameter is related to a distance between the object position estimate and the first software-defined virtual boundary 176. In particular, the first scaling parameter is related to a distance between the object position estimate and the first software-defined virtual boundary 176 when the object position estimate is within the second software-defined virtual boundary 178. Where there is a plurality of objects 113, the closest object to the manned VTOL aerial vehicle 100 is that which is used to determine the magnitude of the first scaling parameter. In other words, the object 113 that corresponds to the object position estimate that is closest to the position estimate is used to determine the magnitude of the first scaling parameter.

FIG. 12 is a schematic diagram illustrating the manned VTOL aerial vehicle 100 with respect to the first software-defined virtual boundary 176, the second software-defined virtual boundary 178 and three example object position estimates. Specifically, FIG. 12 illustrates a first object position estimate 184, a second object position estimate 186 and a third object position estimate 188 as example object position estimates. The first object position estimate 184 is on the first software-defined virtual boundary 176. The second object position estimate 186 is at an intermediate position between the first software-defined virtual boundary 176 and the second software-defined virtual boundary 178. The third object position estimate 188 is on the third software-defined virtual boundary 188.

As previously described, the first scaling parameter is related to a distance between the object position estimate and the first software-defined virtual boundary 176. Specifically, the first scaling parameter is equal to 1 (or is a maximum) when the object position estimate is at or corresponds to the first software-defined virtual boundary 176. The first scaling parameter is equal to zero (or a minimum) when the object position estimate is at or corresponds to the second software-defined virtual boundary 178.

The at least one processor 132 determines an object position estimate ratio for the object position estimate. The object position estimate ratio is a ratio of a first object position estimate distance 183 to a second object position estimate distance 185. The first object position estimate distance 183 is a distance between the object position estimate and the first software-defined virtual boundary 176 in the measurement direction 180 that extends from the position estimate of the manned VTOL aerial vehicle 100 through the object position estimate. In other words, the first object position estimate distance 183 is a distance (D1) along an axis along which the position estimate and the object position estimate are collinear. The second object position estimate distance 185 is a distance (D2) between the first software-defined virtual boundary 176 and the second software-defined virtual boundary 178 in the measurement direction 180 (or the axis as previously described).

The object position estimate ratio (D1/D2) at the first object position estimate 184 is 0. That is, the first object position estimate 184 is at the first software-defined virtual boundary 176. The object position estimate ratio at the second object position estimate 186 is 0.5. That is, the second object position estimate 186 is directly between the first software-defined virtual boundary 176 and the second software-defined virtual boundary 178. The object position estimate ratio at the third object position estimate 188 is 1. That is, the third object position estimate 188 is at the second software-defined virtual boundary.

FIG. 13 is a chart illustrating variation of a magnitude of the first scaling parameter as an object 113 (and therefore, the object position estimate) moves between the first software-defined virtual boundary 176 and the second software-defined virtual boundary 178 (and as it moves beyond the second software-defined virtual boundary 178. An x-axis 190 shows the object position estimate ratio of the object 113. A y-axis 192 shows the magnitude of the first scaling parameter (K).

A number of circles in FIG. 13 illustrate the magnitude of the first scaling parameter when the object position estimate is at each of the previously described first object position estimate 184, second object position estimate 186 and third object position estimate 188.

In the illustrated embodiment, there is a linear relationship between the first scaling parameter and the distance of the object position estimate from the first software-defined virtual boundary 176. It will however be appreciated that other relationships may be used. That is, a scaling factor may not be linear. The scaling factor may be related to the gradient of the line of FIG. 13.

When the object position estimate corresponds to the first object position estimate 184, the magnitude of the first scaling parameter is zero (or a minimum). When the object position estimate corresponds to the second object position estimate 186, the magnitude of the first scaling parameter is 0.5 (or an intermediate number).

The magnitude of the first scaling parameter is direction dependent when the object position estimate is near the second software-defined virtual boundary 178. That is, the magnitude of the first scaling parameter is direction dependent when the object position estimate corresponds to the third object position estimate 188. The magnitude of the first scaling parameter 188A is 1 (or a maximum) when the object position estimate corresponds to the third object position estimate 188 and the object position estimate is moving towards the manned VTOL aerial vehicle 100 (i.e. it is moving from outside the second software-defined virtual boundary 178 to within the second software-defined virtual boundary 178). The magnitude of the first scaling parameter 188B is less than the maximum when object position estimate corresponds to the third object position estimate 188 and the object position estimate is moving away from the manned VTOL aerial vehicle 100 (i.e. it is moving from within the second software-defined virtual boundary 178 to outside the second software-defined virtual boundary 178).

In other words, the at least one processor 132 determines an object position estimate movement direction (e.g. when determining the object state estimate) and introduces a hysteresis 194 to changes in the magnitude of the first scaling parameter if the object position estimate is moving away from the manned VTOL aerial vehicle 100 (i.e. it is moving from within the second software-defined virtual boundary 178 to outside the second software-defined virtual boundary 178). The hysteresis 194 may be introduced by the at least one processor 132 when the object position estimate is moving away from the manned VTOL aerial vehicle 100 and is between a first hysteresis threshold 196 and a second hysteresis threshold 198. The first hysteresis threshold 196 is a distance from the manned VTOL aerial vehicle along the line 180 (or axis as previously described). The second hysteresis threshold 198 is also a distance from the manned VTOL aerial vehicle along the line 180 (or axis as previously described). The first hysteresis threshold 196 is within the second software-defined virtual boundary 178. The second hysteresis threshold 198 is outside the second software-defined virtual boundary 178.

In some embodiments, the first software-defined virtual boundary 176, second software-defined virtual boundary 178, first hysteresis threshold 196 and/or second hysteresis threshold 198 may be as described in “Obstacle avoidance control of a human-in-the-loop mobile robot system using harmonic potential fields”, Zhen Kan et al., (2017), Robotica, the content of which is incorporated herein by reference in its entirety.

At 214, the at least one processor 132 controls the propulsion system 106 of the manned VTOL aerial vehicle 100 to avoid the object 113 (or the plurality of objects 113, where relevant). The at least one processor 132 controls the propeller drive systems 114 to rotate the propellers as necessary to control the manned VTOL aerial vehicle in accordance with the control vector. By controlling the manned VTOL aerial vehicle 100 in accordance with the control vector, the at least one processor 132 controls the manned VTOL aerial vehicle 100 to avoid the object 113 (or the plurality of objects 113, where relevant).

The at least one processor 132 executes the control module 141 to determine the control vector. The at least one processor 132 executes the control module 141 to control the propulsion system 106 of the manned VTOL aerial vehicle 100 to avoid the object 113 (or the plurality of objects 113, where relevant).

The at least one processor 132 may provide an alert to the pilot. The alert may be in the form of a warning. The at least one processor 132 may determine the alert based at least in part on the sensor data. The at least one processor 132 may display the alert using the display of the cockpit 104. In some embodiments, the display is in the form of a heads-up display. In these embodiments, the at least one processor 132 may display the alert using the heads-up display. In some embodiments, the alert may comprise an audio output. In some embodiments, the alert may comprise haptic feedback, for example, through a seat of the cockpit 104 or the pilot-operable controls 118. The at least one processor may execute the cockpit warning system 161 to determine and/or display the alert.

### Computer-Implemented Method 300 for Determining a State Estimate

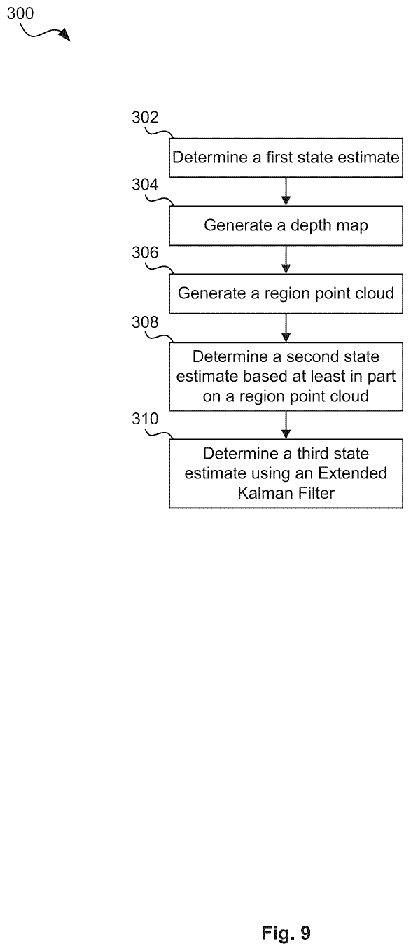

FIG. 9 is a process flow diagram illustrating a computer-implemented method 300 for determining the state estimate of the manned VTOL aerial vehicle 100, according to some embodiments. The computer-implemented method 300 is performed by the control system 116. In some embodiments, the computer-implemented method 300 is performed by the at least one processor 132.

FIG. 9 is to be understood as a blueprint for one or more software programs and may be implemented step-by-step, such that each step in FIG. 9 may, for example, be represented by a function in a programming language, such as C++, C, Python, or Java. The resulting source code is then compiled and stored as computer executable instructions on memory 134.

At 302, the at least one processor 132 determines a first state estimate. The at least one processor 132 also determines a first state estimate confidence metric. The at least one processor 132 determines the first state estimate based at least in part on visual odometry. In particular, the at least one processor 132 determines the first state estimate based at least in part on one or more of the gyroscopic data, the accelerometer data, the altitude data, the magnetic field data and the visible spectrum image data. The first state estimate is indicative of a first position, a first attitude and a first velocity of the manned VTOL aerial vehicle 100 within the region. The first state estimate confidence metric is indicative of a first error associated with the first state estimate.

The at least one processor 132 executes the visual odometry module 137 to determine the first state estimate and the first state estimate confidence metric.

In some embodiments, the first state estimate corresponds to the previously mentioned state estimate. That is, the at least one processor 132 may determine the repulsion vector 254 based at least in part on the first state estimate. In some embodiments, the first state estimate confidence metric corresponds to the previously mentioned state estimate confidence metric. That is, the at least one processor 132 may determine the repulsion vector 254 based at least in part on the first state estimate confidence metric.

At 304, the at least one processor 132 generates a depth map. The depth map is associated with the region. The at least one processor 132 generates the depth map based at least in part on the visible spectrum image data. In some embodiments, the at least one processor 132 generates the depth map using a deep neural network (DNN). The visible spectrum image data may be an input of the DNN.

The at least one processor 132 executes the depth estimating module 135 to generate the depth map. The depth estimating module 135 may be in the form of a DNN trained to recognise depth.

At 306, the at least one processor 132 generates a region point cloud. The point cloud is associated with the region. In some embodiments, the region point cloud represents the region. The at least one processor 132 generates the region point cloud based at least in part on the depth map and the LIDAR data. Outlier points of the depth map and/or the LIDAR data are excluded from the region point cloud.

For example, the LIDAR data may comprise a plurality of LIDAR points. Each LIDAR point is associated with three-dimensional LIDAR point coordinates and a LIDAR point intensity. The intensity may be proportional to a LIDAR point reflectivity. Each intensity is indicative of a reflectivity of a corresponding point of the region on which the LIDAR signal reflected. Therefore, the LIDAR points may be filtered based at least in part on their intensity. The at least one processor 132 may filter the LIDAR points by excluding LIDAR points with a LIDAR point intensity that is below a LIDAR intensity threshold from further processing. The at least one processor 132 may discard these LIDAR points from the LIDAR data.

The region point cloud comprises a plurality of points. The points of the region point cloud may be region point cloud vectors. Each point is associated with three-dimensional coordinates and an intensity. Each intensity is indicative of a reflectivity of a corresponding point of the region or a surface of an object within the region. Therefore, the points may be filtered based at least in part on their intensity. The at least one processor 132 may filter the points by excluding points with an intensity that is below an intensity threshold from further processing. The at least one processor 132 may discard these points from the region point cloud.

The depth map comprises a plurality of points. The points may be pixels. The points of the depth map may be depth map vectors. Each point is associated with coordinates a value. The coordinates may be two-dimensional coordinates. Each value is indicative of a reflectivity of a corresponding point on a surface of the region or a surface of an object within the region. Therefore, the points may be filtered based at least in part on their value. The at least one processor 132 may filter the points by excluding points with a value that is below a value threshold from further processing. The at least one processor 132 may discard these points from the region point cloud.

The at least one processor 132 merges the depth map and the LIDAR data to determine the region point cloud. The at least one processor 132 determines the region point cloud by including the points of the depth map and the points of the LIDAR data in a single point cloud. The at least one processor 132 may convert the depth map to a depth map point cloud based at least in part on the values of each of the points of the depth map. By expressing the LIDAR data and the depth map point cloud in a common reference frame (e.g. that of the manned VTOL aerial vehicle 100), the at least one processor determines the region point cloud. The region point cloud comprises a plurality of region point cloud points. The region point cloud points may be region point cloud vectors. Each region point cloud point is associated with an elevation, azimuth and ranging.

The at least one processor 132 executes the three-dimensional map module 136 to generate the region point cloud.

At 308, the at least one processor 132 determines a second state estimate. The at least one processor 132 also determines a second state estimate confidence metric. The at least one processor 132 determines the second state estimate and the second state estimate confidence metric based at least in part on the region point cloud, the first state estimate and the first state estimate confidence metric. The at least one processor 132 may determine the second state estimate and/or the second state estimate confidence interval based at least in part on the external sensing system data. The second state estimate is indicative of a second position, a second attitude and a second velocity of the manned VTOL aerial vehicle within the region. The second state estimate confidence metric is indicative of a second error associated with the second state estimate.

The at least one processor 132 executes a three-dimensional adaptive Monte Carlo localisation to determine the second state estimate and the second state estimate confidence metric. The region point cloud, the first state estimate and the first state estimate confidence metric are inputs of the three-dimensional adaptive Monte Carlo localisation. The second state estimate and the second state estimate confidence interval are outputs of the three-dimensional adaptive Monte Carlo localisation. The external LIDAR data is an input of the three-dimensional adaptive Monte Carlo localisation.

The at least one processor 132 executes the particle filter module 138 to determine the second state estimate and the second state estimate confidence metric.

In some embodiments, the external sensing system data comprises the second state estimate and/or the second state estimate confidence interval.

In some embodiments, the second state estimate corresponds to the previously mentioned state estimate. That is, the at least one processor 132 may determine the repulsion vector 254 based at least in part on the second state estimate. In some embodiments, the second state estimate confidence metric corresponds to the previously mentioned state estimate confidence metric. That is, the at least one processor 132 may determine the repulsion vector 254 based at least in part on the second state estimate confidence metric.

At 310, the at least one processor 132 determines a third state estimate. The at least one processor 132 also determines a third state estimate confidence metric. The third state estimate comprises a position estimate that is indicative of a position of the manned VTOL aerial vehicle within the region. The third state estimate comprises a speed vector that is indicative of a velocity of the manned VTOL aerial vehicle 100. The third state estimate comprises an attitude vector that is indicative of an attitude of the manned VTOL aerial vehicle 100. The third state estimate confidence metric is indicative of a third error associated with the third state estimate.

The least one processor 132 determines the third state estimate and the third state estimate confidence metric based at least in part on the GNSS data. The least one processor 132 determines the third state estimate and the third state estimate confidence metric based at least in part on the gyroscopic data. The least one processor 132 determines the third state estimate and the third state estimate confidence metric based at least in part on the accelerometer data. The least one processor 132 determines the third state estimate and the third state estimate confidence metric based at least in part on the altitude data. The least one processor 132 determines the third state estimate and the third state estimate confidence metric based at least in part on the magnetic field data. The least one processor 132 determines the third state estimate and the third state estimate confidence metric based at least in part on the second state estimate. The least one processor 132 determines the third state estimate and the third state estimate confidence metric based at least in part on the second state estimate confidence metric. The at least one processor 132 may determine the third state estimate and/or the third state estimate confidence interval based at least in part on the external sensing system data.

In some embodiments, the at least one processor 132 determines the third state estimate and the third state estimate confidence metric using an Extended Kalman Filter. The second state estimate is an input of the Extended Kalman Filter. The second state estimate confidence metric is an input of the Extended Kalman Filter. The gyroscopic data is an input of the Extended Kalman Filter. The accelerometer data is an input of the Extended Kalman Filter. The altitude data is an input of the Extended Kalman Filter. The magnetic field data is an input of the Extended Kalman Filter. The GNSS data is an input of the Extended Kalman Filter

In some embodiments, the at least one processor 132 receives a ground-based state estimate. The ground-based state estimate is indicative of a state of the manned VTOL aerial vehicle 100. The ground-based state estimate comprises a ground-based position estimate. The ground-based position estimate is indicative of the position of the manned VTOL aerial vehicle 100 within the region. The ground-based state estimate comprises a ground-based speed vector. The ground-based speed vector is indicative of the velocity of the manned VTOL aerial vehicle 100. The ground-based state estimate comprises a ground-based attitude vector. The ground-based attitude vector is indicative of the attitude of the manned VTOL aerial vehicle 100.

The ground-based state estimate may be determined by another computing system. For example, the central server system 103 may generate the ground-based state estimate by processing ground-based LIDAR data generated by a ground-based LIDAR system (e.g. the external sensing system 199). Alternatively, the central server system 103 may generate the ground-based state estimate by processing ground-based visual spectrum image data generated by a ground-based visual spectrum image camera. In other words, the external sensing system data may comprise the ground-based state estimate. In some embodiments, the ground-based state estimate is an input of the Extended Kalman Filter.

In some embodiments, each of the inputs of the Extended Kalman Filter may be associated with a respective frequency. For example, the second state estimate may be updated at a second state estimate frequency. The second state estimate confidence metric may be updated at a second state estimate confidence metric frequency. The gyroscopic data may be updated (e.g. provided by the gyroscope 160) at a gyroscopic data frequency. The accelerometer data may be updated (e.g. provided by the accelerometer 158) at an accelerometer data frequency. The altitude data may be updated (e.g. provided by the altimeter 156) at an altitude data frequency. The magnetic field data may be updated (e.g. provided by the magnetometer sensor 162) at a magnetic field data frequency. The ground-based state estimate may be updated at a ground-based state estimate frequency. These frequencies may be referred to as Extended Kalman Filter input frequencies. One or more of these frequencies may be the same. One or more of these frequencies may be different.

In some embodiments, the at least one processor 132 outputs the third state estimate and the third state estimate confidence interval at a third state estimate frequency and a third state estimate confidence interval frequency respectively. These may be referred to as Extended Kalman Filter output frequencies. These frequencies may be the same. This frequency may be the same as a frequency of the state estimate described herein and the state estimate confidence metric described herein. In this case, the relevant frequency may be referred to as the Extended Kalman Filter output frequency. In some embodiments, the Extended Kalman Filter output frequencies are the same as one or more of the Extended Kalman Filter input frequencies. In some embodiments, the Extended Kalman Filter output frequencies are different to one or more of the Extended Kalman Filter input frequencies.

The at least one processor 132 executes the state estimating module 139 to determine the third state estimate and the third state estimate confidence metric.

In some embodiments, the third state estimate is the state estimate referred to in the previously described computer-implemented method 200.

The manned VTOL aerial vehicle 100, the computer-implemented method 200 and the computer-implemented method 300 provide a number of significant technical advantages. As the GNSS module 154 is capable of RTK correction, a global localisation problem is solved. That is, the at least one processor 132 is capable of accurately determining the position estimate and the speed vector 253. In some embodiments, the GNSS module 154 comprises two or more antennae. Thus, the at least one processor 132 can determine the azimuth of the manned VTOL aerial vehicle 100.

In some cases, the GNSS signal can be impeded. For example, when the manned VTOL aerial vehicle 100 is flying near large obstacles or indoors. In these cases, the IMU 121 provides sensor data that enable the at least one processor 132 to determine the state estimate.

When the GNSS data is not available or not accurate, the at least one processor 132 is capable of using the disclosed inertial odometry to provide the state estimate, but this estimation becomes inaccurate over time. Visual odometry module 137 can be used to further improve the accuracy of the state estimates provided by the at least one processor 132 and limit the estimation drift. By exploiting the sensor data (e.g. the LIDAR data) and a pre-determined three-dimensional model of the region, only the states that satisfy a close correlation between predictions and observation are kept. This is the role of the particle filter module 138.

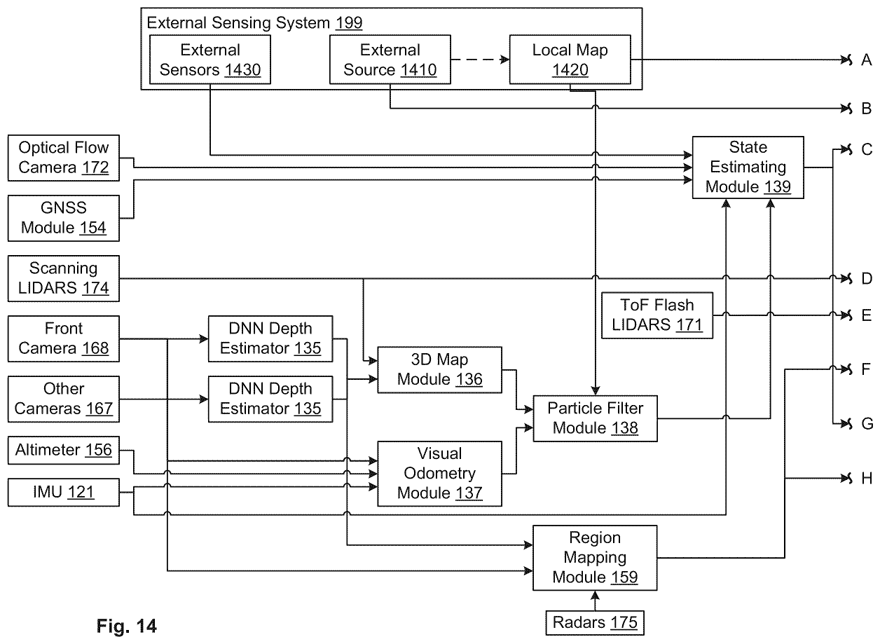

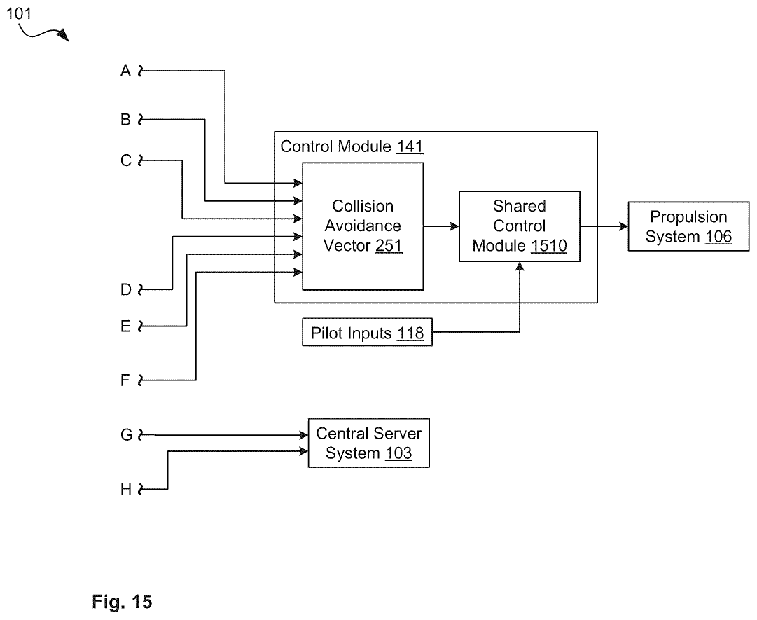

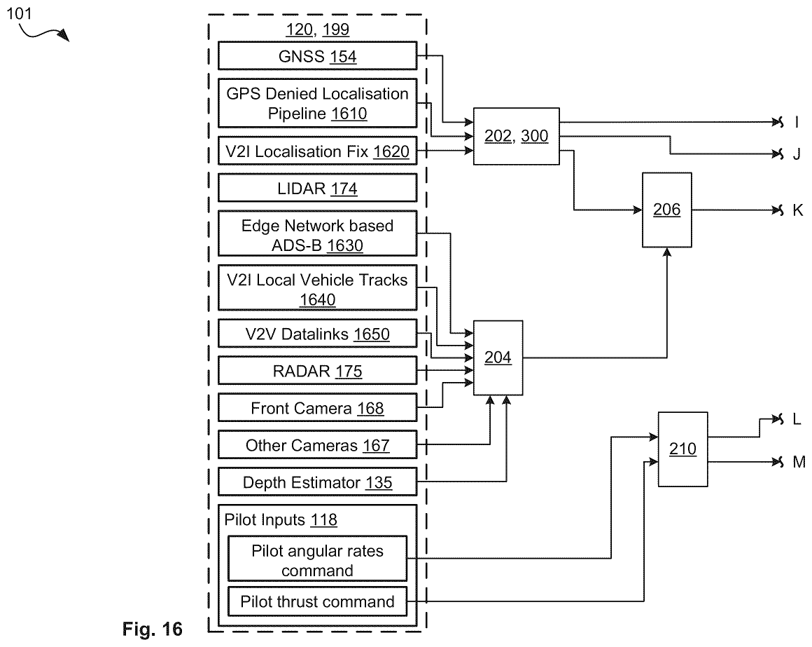

FIG. 14 and FIG. 15 illustrate an example control system 116, according to some embodiments. FIG. 14 illustrates a first portion of the control system 116. FIG. 15 illustrates a second portion of the control system 116. Reference letters A-H indicate a continuation of a line from FIG. 14 to FIG. 15. For example, the line of FIG. 14 marked with “A” is continued at the corresponding “A” on FIG. 15. Similar logic also applies to each of “B” through “H” on FIGS. 14 and 15.

As previously described, the control system 116 comprises the sensing system 120. The illustrated control system comprises the IMU 121. The IMU 121 comprises the magnetometer 162, the altimeter 156, the accelerometer 158 and the gyroscope 160. Alternatively, the altimeter 156 is separate from the IMU 121. The IMU 121 provides sensor data to the visual odometry module 137 and the state estimating module 139. Optionally, optical flow camera 172 provides further image data output to the visual odometry module 137.

The forward-facing camera 168 provides visible spectrum image data to the depth estimating module 135. The other visible spectrum cameras 167 also provide visible spectrum image data to the depth estimating modules 135. As illustrated, the control system 116 may comprise a plurality of depth estimating modules 135. The depth estimating modules 135 provide depth maps to the three-dimensional map module 136 which generates the region point cloud as previously described. The depth estimating modules 135 provide depth maps to the region mapping module 175. The at least one processor 132 determines the first state estimate and the first state estimate confidence interval by executing the visual odometry module 137 as described herein. The at least one processor 132 determines the second state estimate and the second state estimate confidence interval based at least in part on the region point cloud, the first state estimate, and the first state estimate confidence interval by executing the particle filter module 138 as described herein.

The at least one processor 132 executes the state estimating module 139 to determine the third state estimate and the third state estimate confidence interval based at least in part on the second state estimate and the second state estimate confidence interval. The at least one processor 132 may determine the third state estimate and the third state estimate confidence interval based at least in part on optical flow data provided by the visible spectrum cameras 167 and/or optical flow camera 172, GNSS data provided by the GNSS module 154, altitude data provided by altimeter 156, inertial monitoring unit data provided by the IMU 121 and the external data provided by the external sensing system 199, as previously described.

As previously described, the manned VTOL aerial vehicle 100 may use external sensor data from the external sensing system 199 to perform functionality described herein. As shown in FIGS. 14 and 15, the external sensing system 199 may provide input from external sensors 1430, external source 1410, and local map module 1420. External sensors 1430 may include a ground based sensor or another speeder, for example. External sensors 1430 may provide absolute localisation or speeder state via vehicle-to-everything (V2X) communication. External source 1410 may comprise sources of point cloud data, no fly zone data, and virtual object data, for example. External source 1410 may provide data to local map module 1420. Local map module 1420 may use data provided by external source 1410 to generate and provide point cloud data to the control module 141.

The at least one processor 132 executes the region mapping module 159 to determine the object position estimate as described herein. The at least one processor 132 executes the region mapping module 159 to determine an estimated region map as described herein. The at least one processor 132 determines the object position estimate and the estimated region map based at least in part on the visible spectrum image data provided by front camera 168 and other cameras 167, the depth map(s) provided by DNN depth estimators 135, the RADAR data provided by radars 175, and the external sensor data provided by the external sensing system 199. In this case, the external sensor data may comprise an additional vehicle state estimate that is indicative of a state of an additional vehicle. Such data may indicate that an additional vehicle is in the region, for example.

The at least one processor 132 executes the control module 141 to determine the control vector as previously described. The at least one processor 132 executes the control module to control the manned VTOL aerial vehicle 100 to avoid the object 113 as previously described. FIGS. 14 and 15 illustrate a relationship between the inputs to the control module 141, and a relationship between the control module 141 and the propulsion system 106 of the manned VTOL aerial vehicle 100. In some embodiments, the pilot may manipulate the pilot-operable controls to provide pilot inputs 118 to the control module 141, which may include angular rates and thrust. The control module 141 is configured to process pilot inputs 118 in combination with collision avoidance velocity vector 251 via shared control module 1510 as previously described to determine a control vector. This allows the pilot to control the manned VTOL aerial vehicle 100 while still within an overall autonomous collision-avoidance control program.

As illustrated in FIGS. 14 and 15, the manned VTOL aerial vehicle is configured to provide the object position estimate and/or the estimated region map to one or more other vehicles and/or the central server system 103. That is, other vehicles may be allowed access to the estimated region.

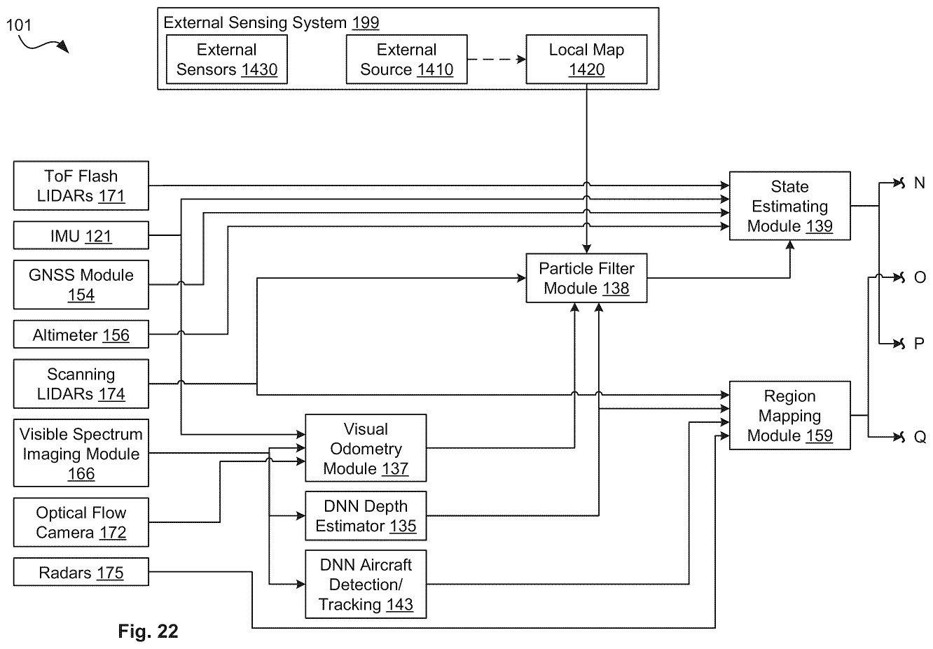

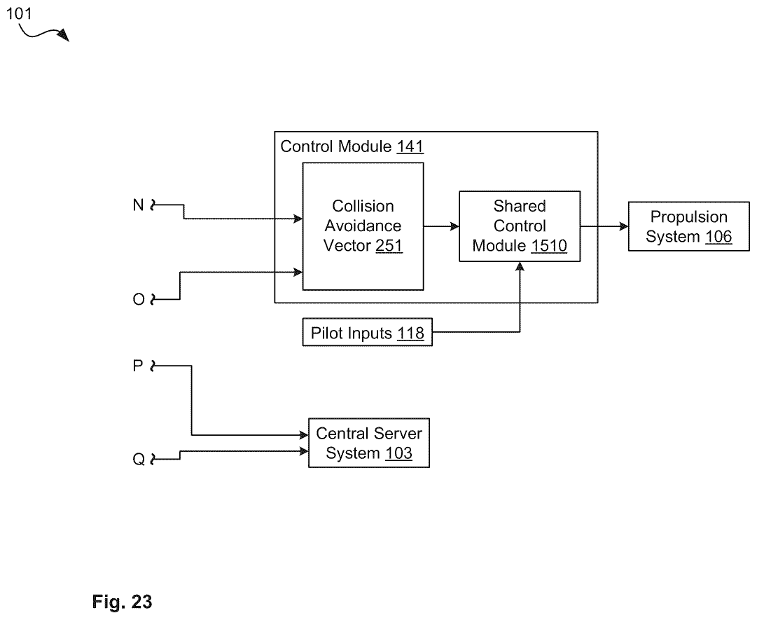

FIG. 22 and FIG. 23 illustrate an alternate example control system 116, according to some embodiments. FIG. 22 illustrates a first portion of the control system 116. FIG. 23 illustrates a second portion of the control system 116. Reference letters N-Q indicate a continuation of a line from FIG. 22 to FIG. 23. For example, the line of FIG. 22 marked with “N” is continued at the corresponding “N” on FIG. 23. Similar logic also applies to each of “O” through “Q” on FIGS. 22 and 23.

The alternate control system 116 as shown in FIGS. 22 and 23 is essentially the same and functions in the same way as the control system 116 shown and described in relation to FIGS. 14 and 15 (and elsewhere herein), but with some modifications to inputs and outputs as follows.

In some embodiments, the scanning LIDARS 174 is not an input to the control module 141. The scanning LIDARS 174 may be an input to region mapping module 159. The region mapping module 159 may determine either the region state estimate or the object position estimate, as described herein, based at least in part on LIDAR data provided by the scanning LIDARS 174. The scanning LIDARS 174 may be an input to the particle filter module 138. The particle filter module 138 may determine the second state estimate and/or the second state estimate confidence metric, as described herein, based at least in part on LIDAR data provided by the scanning LIDARS 174. In some embodiments, the DNN depth estimator 135 may be an input to the particle filter module 138. The particle filter module 138 may determine the second state estimate and/or the second state estimate confidence metric, as described herein, based at least in part on the depth map provided by the DNN depth estimator 135. In some embodiments, the DNN depth estimator 135 may not be required.

In some embodiments, the altimeter 156 may be a direct input to the state estimation module 139. The state estimation module 139 may determine the third state estimate and/or the third state estimate confidence metric, as described herein, based at least in part on altitude data provided by the altimeter 156. In some embodiments, visual odometry module 137 may not determine the first state estimate based at least in part on altitude data provided by altimeter 156. In some embodiments, the optical flow camera 172 is not an input of the state estimation module 139. That is, state estimation module 139 may not determine the third state estimate and/or the third state estimate confidence metric, as described herein, based at least in part on optical flow data provided by the optical flow camera 172. Optical flow camera 172 may be an input of visual odometry module 137. Visual odometry module 137 may determine the egomotion estimate, as described herein, based at least in part on the optical flow data provided by the optical flow camera 172.

FIGS. 16 and 17 illustrate a schematic diagram of a plurality of components of the control system 116, a plurality of the steps of the computer-implemented method 200, and a plurality of steps of the computer-implemented method 300. Specifically, FIG. 16 illustrates a first portion of the schematic diagram and FIG. 17 illustrates a second portion of the schematic diagram. Reference letters I-M indicate a continuation of a line from FIG. 16 to FIG. 17. For example, the line of FIG. 16 marked with “I” is continued at the corresponding “I” on FIG. 17. Similar logic also applies to each of “J” through “M” on FIGS. 16 and 17.

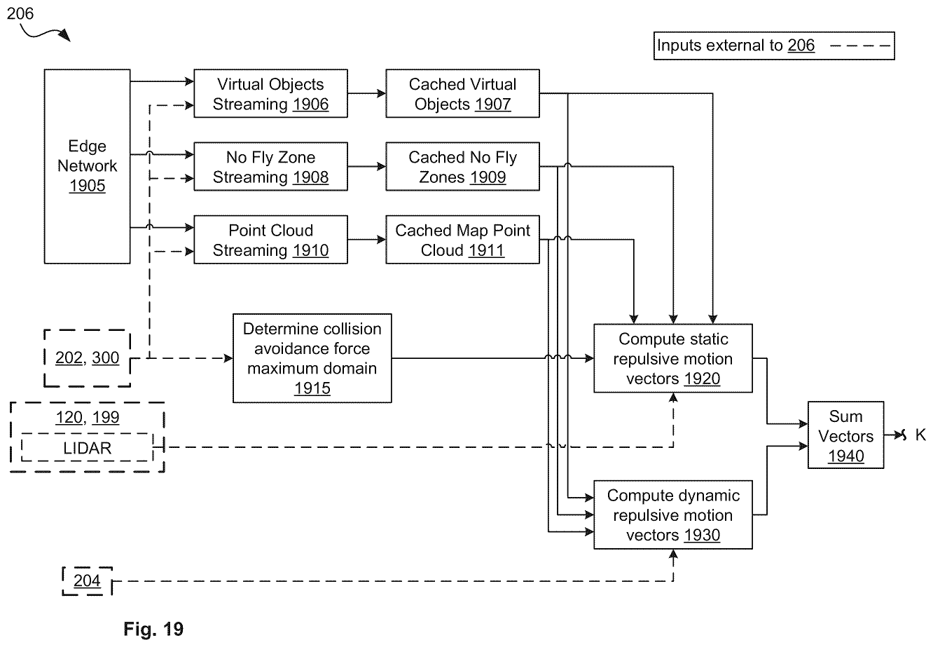

As shown in FIG. 16, at 202, the at least one processor 132 receives inputs from GNSS 154, GPS denied localisation pipeline 1610, and vehicle-to-infrastructure (V2I) localisation fix 1620 to determine a state estimate comprising position, attitude, and velocity data outputs as previously described. At 204, the at least one processor 132 receives input from Edge network based automatic dependent surveillance broadcast (ADS-B) 1630, V2I local vehicle tracks 1640, vehicle-to-vehicle (V2V) datalinks 1650, RADAR 175, front camera 168, other cameras 167, and depth estimator 135 to generate a repulsion potential field model or a region around the vehicle as previously described. From step 202 and step 204, the at least one processor 132 generates a state estimate of the manned VTOL aerial vehicle, and a repulsion potential field model of a region around the vehicle, respectively, which are used at 206 (FIG. 19) to determine repulsion vector 254. At 210, pilot inputs 118 are used by the at least one processor 132 to determine an input vector.

In FIG. 17 at 208, a collision avoidance velocity vector 251 is determined as previously described in reference to FIG. 11. In some embodiments, the at least one processor 132 executes collision avoidance module 140, wherein the speed vector 253 and repulsion vector 254 are summed to determine the speed component of the collision avoidance velocity vector 251. Similarly, to determine the attitude components of the collision avoidance velocity vector, the repulsion vector 254 and the attitude outputs of computer-implemented method 300 (at 202) are summed by the at least one processor 132.

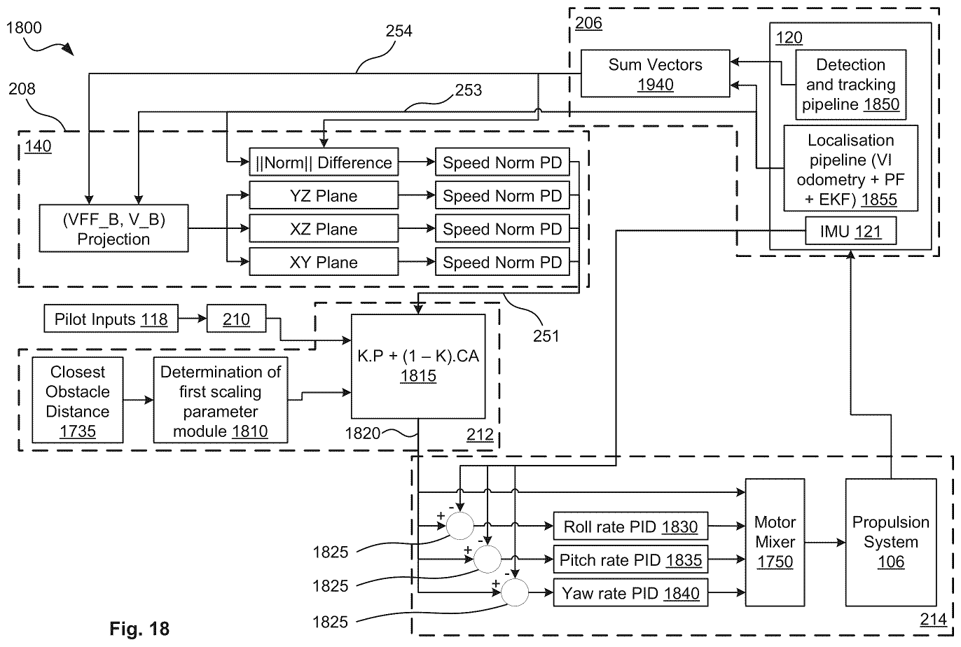

The at least one processor 132 then scales the collision avoidance velocity vector attitude components with the attitude component of the pilot inputs 118 by executing weight rates command module 1730 and angular rate controller 1740 to determine a scaled collision avoidance velocity vector as previously described. The at least one processor 132 also scales the collision avoidance velocity vector speed component with the thrust component of the pilot inputs 118 by executing weight avoidance thrust module 1750 to determine a scaled input vector as previously described. The scaled collision avoidance velocity vector components are then added together via motor mixer 1760 when executed by the at least one processor 132. The resulting control vector is then output to process 214 wherein the control vector is processed by processer 132 to control the propulsion system 116 of the vehicle to avoid an object as later described in relation to FIG. 18.

FIG. 18 illustrates a schematic diagram of a plurality of components of the manned VTOL aerial vehicle 100 and a plurality of the steps of the computer-implemented method 200. Specifically, FIG. 18 illustrates some of the functionality of the control system 116. The architecture of FIG. 18 may form, or be part of a controller 1800 of the control system 116.

As shown in FIG. 18, a plurality of components of the manned VTOL aerial vehicle 100 are involved in the step 208 of determining the collision avoidance velocity vector. For example, the sensing system 120 is involved in the step 208 of determining the collision avoidance velocity vector (which may also be referred to as a virtual force field motion vector).

Further illustrated in FIG. 18, sensing unit 120 executes detection and tracking pipeline 1850 and localisation pipeline 1855. Detection and tracking pipeline 1850 generates an output speed vector 253, acquired from processing inputs front camera 168, other cameras 167, and depth estimator 135 via step 204 and step 206 from computer-implemented method 200. Localisation pipeline 1855 generates an output repulsion vector 254, acquired from processing outputs from visual odometry module 137, particle filter module 138, and state estimating module 139 from performing processes 202 and 204 from computer-implemented method 200. At step 206, outputs of detection and tracking pipeline 1850 and localisation pipeline 1855 are combined to produce repulsion vector 254, as described herein.

As previously described, the repulsion vector 254 is then processed by the at least one processor 132 at step 208 via collision avoidance module 140 to determine a collision avoidance velocity vector 251. The at least one processor 132 may determine the collision avoidance velocity vector 251 at a frequency of approximately 10 Hz.

As shown in FIG. 18, and as described herein, determining the control vector 1820 via module 1815 involves the collision avoidance velocity vector 251, the input vector received via the pilot-operable controls 118 via step 210, and the determination of the first scaling parameter via module 1810 as described previously, using the closest obstacle distance 1735 as input. The control system 116 controls the propulsion system 106 based at least in part on the control vector 1820, as described herein.

The controller 1800 at step 214 may comprise one or more of a roll rate proportional-integral-derivative (PID) controller 1830, a pitch rate PID controller 1835, and a yaw rate PID 1840, each in combination with a summation module 1825. Summation module 1825 calculates the difference between the input control vector 1820 and the output of the IMU 121. That is, the control system 116 may comprise a nested PID controller architecture. One or more of these controllers may be used to control the manned VTOL aerial vehicle 100 to avoid the object 113 at step 214.

In some embodiments, the collision avoidance module 140 or the control system 116 involves or implements model predictive control (MPC).

FIG. 19 illustrates a schematic diagram of a portion of the computer-implemented method 200, specifically 206, performed by the at least one processor 132. At 206, repulsion vector 254 is determined via processing inputs provided by computer-implemented method 300, sensing system 120, step 204, and edge network 1905, as previously described. When executed by the at least one processor 132, software code module 1920 computes the static components of the repulsive motion vectors, and software code module 1930 computes the dynamic components of the repulsive motion vectors. These components are then summed by the at least one processor 132 by executing software code module 1940 to determine the repulsion vector 254.

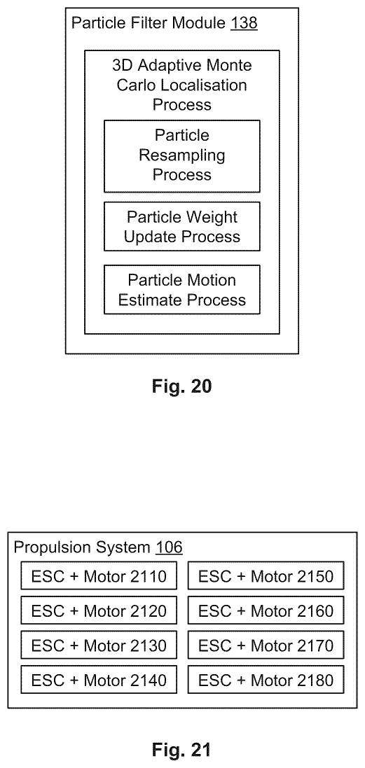

FIG. 20 is a schematic diagram of a portion of the control system 116, specifically particle filter module 138. Particle filter module 138 utilises three-dimensional adaptive Monte Carlo localisation to determine a second state estimate and a second state estimate confidence interval as described herein.

FIG. 21 is a block diagram of propulsion system 106 according to some embodiments. Propulsion system 106 may comprise a plurality of electronic speed controller (ESC) and motor pairs 2110, 2120, 2130, 2140, 2150, 2160, 2170, and 2180. The four ESC and motor pairs are used to control pairs of the propellers. Propulsion system 106 is carried by the body 102 to propel the body 102 during flight.

### Alternative Control System 116 Architecture

Although the manned VTOL aerial vehicle 100 has been described with reference to the control system 116 of FIG. 4, it will be understood that the manned VTOL aerial vehicle 100 may comprise alternative control system 116 architecture. FIG. 5 illustrates an alternative control system 116, according to some embodiments.

FIG. 5 is a block diagram of the control system 116, according to some embodiments. The control system 116 illustrated in FIG. 5 comprises a first control system 142 and a second control system 144. The first control system 142 comprises at least one first control system processor 146. The at least one first control system processor 146 is configured to be in communication with first control system memory 148. The sensing system 120 is configured to communicate with the at least one first control system processor 146. The sensing system 120 may be as previously described. In some embodiments, the sensing system 120 is configured to provide the sensor data to the at least one first control system processor 146. In some embodiments, the at least one first control system processor 146 is configured to receive the sensor data from the sensing system 120. In some embodiments, the at least one first control system processor 146 is configured to retrieve the sensor data from the sensing system 120. The at least one first control system processor 146 is configured to store the sensor data in the first control system memory 148.

The at least one first control system processor 146 is configured to execute first control system program instructions stored in first control system memory 148 to cause the first control system 142 to function as described herein. In particular, the at least one first control system processor 146 is configured to execute the first control system program instructions to cause the manned VTOL aerial vehicle 100 to function as described herein. In other words, the first control system program instructions are accessible by the at least one first control system processor 146, and are configured to cause the at least one first control system processor 146 to function as described herein.

In some embodiments, the first control system program instructions are in the form of program code. The at least one first control system processor 146 comprises one or more microprocessors, central processing units (CPUs), application specific instruction set processors (ASIPs), application specific integrated circuits (ASICs)), graphics processing units (GPUs), tensor processing units (TPUs), field-programmable gate arrays (FPGAs) or other processors capable of reading and executing program code. The first control system program instructions comprise the depth estimating module 135, the three-dimensional map module 136, the visual odometry module 137, the particle filter module 138, the region mapping mould 159 and the collision avoidance module 140.

First control system memory 148 may comprise one or more volatile or non-volatile memory types. For example, first control system memory 148 may comprise one or more of random access memory (RAM), read-only memory (ROM), electrically erasable programmable read-only memory (EEPROM) or flash memory. First control system memory 148 is configured to store program code accessible by the at least one first control system processor 146. The program code may comprise executable program code modules. In other words, first control system memory 148 is configured to store executable code modules configured to be executable by the at least one first control system processor 146. The executable code modules, when executed by the at least one first control system processor 146 cause the at least one first control system processor 146 to perform certain functionality, as described herein. In the illustrated embodiment, the depth estimating module 135, the three-dimensional map module 136, the visual odometry module 137, the particle filter module 138, the DNN detection and tracking module 143, and the collision avoidance module 140 are in the form of program code stored in the first control system memory 148.

The second control system 144 comprises at least one second control system processor 150. The at least one second control system processor 150 is configured to be in communication with second control system memory 152. The sensing system 120 is configured to communicate with the at least one second control system processor 150. The sensing system 120 may be as previously described. The at least one second control system processor 150 is configured to execute second control system program instructions stored in second control system memory 152 to cause the second control system 144 to function as described herein. In particular, the at least one second control system processor 150 is configured to execute the second control system program instructions to cause the manned VTOL aerial vehicle 100 to function as described herein. In other words, the second control system program instructions are accessible by the at least one second control system processor 150, and are configured to cause the at least one second control system processor 150 to function as described herein.

In some embodiments, the second control system 144 comprises some or all of the sensing system 120. The control system 120 may be as previously described. The sensing system 120 is configured to communicate with the at least one second control system processor 150. In some embodiments, the sensing system 120 is configured to provide the sensor data to the at least one second control system processor 150. In some embodiments, the at least one second control system processor 150 is configured to receive the sensor data from the sensing system 120. In some embodiments, the at least one second control system processor 150 is configured to retrieve the sensor data from the sensing system 120. The at least one second control system processor 150 is configured to store the sensor data in the second control system memory 152.

In some embodiments, the second control system program instructions are in the form of program code. The at least one second control system processor 150 comprises one or more microprocessors, central processing units (CPUs), application specific instruction set processors (ASIPs), application specific integrated circuits (ASICs)), graphics processing units (GPUs), tensor processing units (TPUs), field-programmable gate arrays (FPGAs) or other processors capable of reading and executing program code. The second control system program instructions comprise the state estimating module 139, the cockpit warning module 161 and the control module 141.

Second control system memory 152 may comprise one or more volatile or non-volatile memory types. For example, second control system memory 152 may comprise one or more of random access memory (RAM), read-only memory (ROM), electrically erasable programmable read-only memory (EEPROM) or flash memory. Second control system memory 152 is configured to store program code accessible by the at least one second control system processor 150. The program code may comprise executable program code modules. In other words, second control system memory 152 is configured to store executable code modules configured to be executable by the at least one second control system processor 150. The executable code modules, when executed by the at least second control system processor 150 cause the at least one second control system processor 150 to perform certain functionality, as described herein. In the illustrated embodiment, the control module 140 is in the form of program code stored in the second control system memory 152.

The first control system 142 is configured to communicate with the second control system 144. The first control system 142 may comprise a first control system network interface (not shown). The first control system network interface is configured to enable the first control system 142 to communicate with the second control system 144 over one or more communication networks. In particular, the first control system processor 146 may be configured to communicate with the second control system processor 150 using the first control system network interface. The first control system 142 may comprise a combination of network interface hardware and network interface software suitable for establishing, maintaining and facilitating communication over a relevant communication channel. Examples of a suitable communications network include a communication bus, cloud server network, wired or wireless network connection, cellular network connection, Bluetooth™ or other near field radio communication, and/or physical media such as a Universal Serial Bus (USB) connection.

The second control system 144 may comprise a second control system network interface (not shown). The second control system network interface is configured to enable the second control system 144 to communicate with the first control system 142 over one or more communication networks. In particular, the second control system processor 150 may be configured to communicate with the first control system processor 146 using the second control system network interface. The second control system 144 may comprise a combination of network interface hardware and network interface software suitable for establishing, maintaining and facilitating communication over a relevant communication channel. Examples of a suitable communications network include a communication bus, cloud server network, wired or wireless network connection, cellular network connection, Bluetooth™ or other near field radio communication, and/or physical media such as a Universal Serial Bus (USB) connection.

The first control system 142 may be considered a high-level control system. That is, the first control system 142 may be configured to perform computationally expensive tasks. The second control system 144 may be considered a low-level control system. The second control system 144 may be configured to perform computationally less-expensive tasks than the first control system 144.

The computer implemented method 200 may be executed by the control system 116 of FIG. 5. In some embodiments, one or more of steps 202, 204, 206, 208, 210, 212 and 214 are executed by the first control system processor 146. In some embodiments, one or more of steps 202, 204, 206, 208, 210, 212 and 214 are executed by the second control system processor 150. Furthermore, the computer-implemented method 300 may be executed by the control system 116 of FIG. 5. In some embodiments, one or more of steps 302, 304, 306, 308 and 310 are executed by the first control system processor 146. In some embodiments, one or more of steps 302, 304, 306, 308 and 310 are executed by the second control system processor 150.

In particular, the first control system processor 146 is configured to at least partially determine the state estimate of the manned VTOL aerial vehicle 100 (step 202), generate the repulsion potential field model of the region around the vehicle (step 204), determine the repulsion vector (step 206) and determine the collision avoidance velocity vector 251 (step 208).

The second control system processor 150 is configured to at least partially determine the state estimate of the manned VTOL aerial vehicle 100 (step 202), determine the input vector (step 210), determine the control vector (step 212) and control the propulsion system 106 to avoid the object 113 (step 214).

With reference to the computer-implemented method 300 (i.e. determining the state estimate), the first control system processor 146 is configured to determine the first state estimate (step 302), generate the depth map (step 304), generate the region point cloud (step 306) and determine the second state estimate (step 308).

The second control system processor 150 is configured to determine the third state estimate using the Extended Kalman Filter (step 310).

### Alternative Piloting System

In some embodiments, the manned VTOL aerial vehicle 100 may be piloted remotely. That is, the manned VTOL aerial vehicle 100 may comprise a remote cockpit 104. In other words, the cockpit 104 may be in the form of a remote cockpit 104. The remote cockpit 104 may be in a different location to that of the manned VTOL aerial vehicle 100. For example, the remote cockpit 104 may be in a room that is separated from the manned VTOL aerial vehicle 100 (e.g. a cockpit replica ground station).

The remote cockpit 104 can be similar or identical to the cockpit 104. That is, the remote cockpit 104 may comprise the pilot-operable controls 118. The remote cockpit 104 may comprise a remote cockpit communication system. The remote cockpit communication system is configured to enable the remote cockpit 104 to communicate with the manned VTOL aerial vehicle 100. For example, the remote cockpit 104 may communicate with the manned VTOL aerial vehicle 100 via a radio frequency link. In some embodiments, the remote cockpit 104 may communicate with the manned VTOL aerial vehicle 100 using the communications network 105. The remote cockpit 104 may provide the input vector to the manned VTOL aerial vehicle 100. In particular, the at least one processor 132 (or the control system 116) may receive the input vector from the remote cockpit 104.

The manned VTOL aerial vehicle 100 is configured to communicate with the remote cockpit 104 using the communication system 122. The manned VTOL aerial vehicle 100 may be configured to communicate with the remote cockpit 104 via the radio frequency link and/or the communications network 105. The manned VTOL aerial vehicle 100 is configured to provide vehicle data to the remote cockpit 104. For example, the manned VTOL aerial vehicle 100 is configured to provide a video feed and/or telemetry data to the remote cockpit 104. The remote cockpit 104 may comprise a cockpit display configured to display the video feed and/or telemetry data for the pilot.

### Unmanned VTOL Aerial Vehicle

In some embodiments, the manned VTOL aerial vehicle 100 may instead be an unmanned VTOL aerial vehicle. In such a case, the unmanned VTOL aerial vehicle may not include the cockpit 104. Furthermore, the pilot-operable control system 118 may be remote to the unmanned VTOL aerial vehicle. Alternatively, the unmanned VTOL aerial vehicle may be an autonomous unmanned VTOL aerial vehicle.

In some embodiments, the manned VTOL aerial vehicle 100 may be autonomously controlled. For example, the manned VTOL aerial vehicle 100 may be autonomously controlled during take-off and landing. The control system 116 may autonomously control the manned VTOL aerial vehicle 100 during these phases. In other words, the manned VTOL aerial vehicle 100 may be configured to be autonomously or manually switched between a fully autonomous control mode, in which pilot input to the pilot-operable controls is ignored for flight control purposes, and a shared control mode, in which the pilot can assume manual flight control of the vehicle 100 within an overall autonomous collision-avoidance control program.

Some embodiments relate to a manned vertical take-off and landing (VTOL) aerial vehicle. An example vehicle comprises: a body comprising a cockpit; a propulsion system carried by the body to propel the body during flight; pilot-operable controls accessible from the cockpit; and a control system comprising: a sensing system, at least one processor, and memory storing program instructions accessible by the at least one processor. The instructions are configured to cause the at least one processor to: determine a state estimate that is indicative of a state of the manned VTOL aerial vehicle within a region around the manned VTOL aerial vehicle; generate a repulsion potential field model of the region based at least in part on sensor data generated by the sensing system; determine an input vector based at least in part on input received by the pilot-operable controls, the input vector being indicative of an intended angular velocity of the manned VTOL aerial vehicle and an intended thrust of the manned VTOL aerial vehicle; determine a control vector; and control the propulsion system, based at least in part on the control vector, such that the manned VTOL aerial vehicle avoids an object in the region.

Some embodiments relate to an electric VTOL vehicle that has a body with four wings that each carry at least one propeller at a distal end thereof, the body defining a cockpit in the form of a monocoque sized to accommodate an adult human pilot. The body carries at least one electric battery configured to store energy sufficient to power the vehicle for multiple minutes. The body carries an on-board computer and a sensor array. The on-board computer is configured to perform control, navigation and operation functions as described herein based at least in part on signals and/or data received from the sensor array. The on-board computer includes a control system and is configured to allow pilot input to the control system.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A manned vertical take-off and landing (VTOL) aerial vehicle comprising:
a body comprising a cockpit;
a propulsion system carried by the body to propel the body during flight;
pilot-operable controls accessible from the cockpit;
a control system comprising:
a sensing system;
at least one processor; and
memory storing program instructions accessible by the at least one processor, and configured to cause the at least one processor to:
determine a state estimate that is indicative of a state of the manned VTOL aerial vehicle within a region around the manned VTOL aerial vehicle, wherein the state estimate comprises:
a position estimate that is indicative of a position of the manned VTOL aerial vehicle within the region;
a speed vector that is indicative of a velocity of the manned VTOL aerial vehicle; and
an attitude vector that is indicative of an attitude of the manned VTOL aerial vehicle;
generate a repulsion potential field model of the region based at least in part on sensor data generated by the sensing system, wherein:
the region comprises an object; and
the repulsion potential field model is associated with an object state estimate that is indicative of a state of the object;
determine a repulsion vector, based at least in part on the repulsion potential field model and the state estimate;
determine a collision avoidance velocity vector based at least in part on the speed vector and the repulsion vector;
determine an input vector based at least in part on input received by the pilot-operable controls, the input vector being indicative of an intended angular velocity of the manned VTOL aerial vehicle and an intended thrust of the manned VTOL aerial vehicle;
determine a control vector based at least in part on the collision avoidance velocity vector and the input vector; and
control the propulsion system, based at least in part on the control vector, such that the manned VTOL aerial vehicle avoids the object.

2. The manned VTOL aerial vehicle of claim 1, wherein:
the sensing system comprises a Global Navigation Satellite System (GNSS) module configured to generate GNSS data that is indicative of a latitude and a longitude of the manned VTOL aerial vehicle;
the sensor data comprises the GNSS data;
wherein determining the state estimate comprises:
determining the GNSS data; and
determining the state estimate based at least in part on the GNSS data.

3. (canceled)

4. The manned VTOL aerial vehicle of claim 1, wherein the sensing system comprises one or more of:
an altimeter configured to provide, to the at least one processor, altitude data that is indicative of an altitude of the manned VTOL aerial vehicle;
an accelerometer configured to provide, to the at least one processor, accelerometer data that is indicative of an acceleration of the manned VTOL aerial vehicle;
a gyroscope configured to provide, to the at least one processor, gyroscopic data that is indicative of an orientation of the manned VTOL aerial vehicle; and
a magnetometer sensor configured to provide, to the at least one processor, magnetic field data that is indicative of an azimuth orientation of the manned VTOL aerial vehicle; and
wherein the sensor data comprises one or more of the altitude data, the acceleration data, the gyroscopic data and the magnetic field data; and
wherein determining the state estimate comprises:
determining one or more of the altitude data, accelerometer data, gyroscopic data and magnetic field data; and
determining the state estimate based at least in part on one or more of the altitude data, the accelerometer data, the gyroscopic data and the magnetic field data.

5. (canceled)

6. The manned VTOL aerial vehicle of claim 1, wherein:
the sensing system comprises an imaging module configured to provide, to the at least one processor, image data that is associated with the region; and
the sensor data comprises the image data;
wherein the imaging module comprises at least one of:
a light detection and ranging (LIDAR) system configured to generate LIDAR data;
a visible spectrum imaging module configured to generate visible spectrum image data; or
a radio detecting and ranging (RADAR) system configured to generate RADAR data; and
wherein the image data comprises one or more of the LIDAR data, the visible image data and the RADAR data.

7-9. (canceled)

10. The manned VTOL aerial vehicle of claim 1, wherein determining the state estimate comprises:
determining a longitudinal velocity estimate that is indicative of a longitudinal velocity of the manned VTOL aerial vehicle, based at least in part on image data captured by a ground-facing camera mounted on the manned VTOL aerial vehicle;
determining an acceleration estimate that is indicative of an acceleration of the manned VTOL aerial vehicle, based at least in part on accelerometer data;
determining an orientation estimate that is indicative of an orientation of the manned VTOL aerial vehicle, based at least in part on gyroscopic data;
determining an azimuth orientation estimate of the manned VTOL aerial vehicle, based at least in part on magnetic field data; and
determining an altitude estimate that is indicative of an altitude of the manned VTOL aerial vehicle, based at least in part on altitude data.

11. (canceled)

12. The manned VTOL aerial vehicle of claim 1, wherein determining the state estimate comprises:
generating a three-dimensional point cloud representing the region;
determining an initial state estimate that is indicative of an estimated initial state of the manned VTOL aerial vehicle;
comparing the three-dimensional point cloud to a three-dimensional model of the region; and
determining an updated state estimate based at least in part on a result of the comparing; and
wherein the state estimate corresponds to the updated state estimate.

13. (canceled)

14. The manned VTOL aerial vehicle of claim 1, wherein the object state estimate comprises one or more of:
an object position estimate that is indicative of a position of the object within the region;
an object speed vector that is indicative of a velocity of the object; and
an object attitude vector that is indicative of an attitude of the object.

15-16. (canceled)

17. The manned VTOL aerial vehicle of claim 14, wherein generating the repulsion potential field model comprises defining a first software-defined virtual boundary of the potential field model, the first software-defined virtual boundary surrounding the position estimate; and
wherein a magnitude of the repulsion vector is a maximum when the object position estimate is on or within the first software-defined virtual boundary.

18. The manned VTOL aerial vehicle of claim 17, wherein generating the repulsion potential field model comprises defining a second software-defined virtual boundary of the potential field model, the second software-defined virtual boundary surrounding the position estimate and the first software-defined virtual boundary; and
wherein the magnitude of the repulsion vector is zero when the object position estimate is outside the second software-defined virtual boundary.

19. The manned VTOL aerial vehicle of claim 18, wherein the magnitude of the repulsion vector is based at least partially on:
a distance between the object position estimate and the first software-defined virtual boundary in a measurement direction; and
a distance between the object position estimate and the second software-defined virtual boundary in the measurement direction.

20-69. (canceled)

70. A manned VTOL aerial vehicle comprising:
a body comprising a cockpit;
a propulsion system carried by the body, to propel the body during flight;
pilot-operable controls accessible from the cockpit;
a sensing system configured to generate sensor data, the sensing system comprising:
a GNSS module configured to generate GNSS data that is indicative of a latitude and a longitude of the manned VTOL aerial vehicle within a region;
a LIDAR system configured to generate LIDAR data associated with the region;
a visible spectrum camera configured to generate visible spectrum image data associated with the region;
a gyroscope configured to generate gyroscopic data that is indicative of an orientation of the manned VTOL aerial vehicle;
an accelerometer configured to generate accelerometer data that is indicative of an acceleration of the manned VTOL aerial vehicle;
an altimeter configured to generate altitude data that is indicative of an altitude of the manned VTOL aerial vehicle;
a magnetometer sensor configured to generate magnetic field data that is indicative of an azimuth orientation of the manned VTOL aerial vehicle;
at least one processor; and
memory storing program instructions accessible by the at least one processor, and configured to cause the at least one processor to:
generate a depth map based at least in part on the visible spectrum image data;
generate a region point cloud based at least in part on the depth map and the LIDAR data;
determine a first state estimate and a first state estimate confidence metric, based at least in part on the gyroscopic data, the accelerometer data, the altitude data, the magnetic field data and the visible spectrum image data, wherein:
the first state estimate is indicative of a first position, a first attitude and a first velocity of the manned VTOL aerial vehicle within the region; and
the first state estimate confidence metric is indicative of a first error associated with the first state estimate;
determine a second state estimate and a second state estimate confidence metric, based at least in part on the region point cloud, the first state estimate and the first state estimate confidence metric, wherein:
the second state estimate is indicative of a second position, a second attitude and a second velocity of the manned VTOL aerial vehicle within the region; and
the second state estimate confidence metric is indicative of a second error associated with the second state estimate;
determine a third state estimate and a third state estimate confidence metric, based at least in part on the GNSS data, the gyroscopic data, the accelerometer data, the altitude data, the magnetic field data, the second state estimate and the second state estimate confidence metric, wherein:
the third state estimate comprises:
a position estimate that is indicative of a position of the manned VTOL aerial vehicle within the region;
a speed vector that is indicative of a velocity of the manned VTOL aerial vehicle; and
an attitude vector that is indicative of an attitude of the manned VTOL aerial vehicle; and
the third state estimate confidence metric is indicative of a third error associated with the third state estimate;
determine an object state estimate of an object within the region;
generate a repulsion potential field model of the region based at least in part on the sensor data, wherein the repulsion potential field model is associated with the object state estimate;
determine a repulsion vector, based at least in part on the repulsion potential field model and the third state estimate;
determine a collision avoidance velocity vector based at least in part on the repulsion vector and the third state estimate;
determine a control vector based at least in part on the collision avoidance velocity vector and an input vector, the input vector being received via the pilot-operable controls, and being indicative of an intended angular velocity of the manned VTOL aerial vehicle and an intended thrust of the manned VTOL aerial vehicle; and
control the propulsion system, based at least in part on the control vector, such that the manned VTOL aerial vehicle avoids the object.

71. (canceled)

72. The manned VTOL aerial vehicle of claim 70, wherein generating the region point cloud comprises merging the depth map and the LIDAR data.

73. The manned VTOL aerial vehicle of claim 72, wherein outlier points of the depth map and/or the LIDAR data are excluded from the region point cloud.

74-76. (canceled)

77. The manned VTOL aerial vehicle of claim 70, wherein the program instructions are further configured to cause the at least one processor to receive external LIDAR data from an external LIDAR data source, the external LIDAR data comprising an external region point cloud representing the region.

78-84. (canceled)

85. The manned VTOL aerial vehicle of claim 70, wherein the object state estimate comprises one or more of:
an object position estimate that is indicative of a position of the object within the region;
an object speed estimate that is indicative of a velocity of the object; and
an object attitude estimate that is indicative of an attitude of the object.

86. (canceled)

87. The manned VTOL aerial vehicle of claim 85, wherein generating the repulsion potential field model comprises defining a first software-defined virtual boundary of the potential field model, the first software-defined virtual boundary surrounding the position estimate; and
wherein a magnitude of the repulsion vector is a maximum when the object position estimate is on or within the first software-defined virtual boundary.

88. The manned VTOL aerial vehicle of claim 87, wherein generating the repulsion potential field model comprises defining a second software-defined virtual boundary of the potential field model, the second software-defined virtual boundary surrounding the position estimate and the first software-defined virtual boundary; and
wherein the magnitude of the repulsion vector is zero when the object position estimate is outside the second software-defined virtual boundary.

89. The manned VTOL aerial vehicle of claim 88, wherein the magnitude of the repulsion vector is based at least partly on:
a distance between the object position estimate and the first software-defined virtual boundary in a measurement direction; and
a distance between the object position estimate and the second software-defined virtual boundary in the measurement direction.

90. (canceled)

91. The manned VTOL aerial vehicle of claim 70, wherein determining the repulsion vector comprises determining a gradient of the repulsion potential field model at the position estimate.

92. (canceled)

93. The manned VTOL aerial vehicle of claim 70, wherein determining the control vector comprises:
scaling the input vector by a first scaling parameter to provide a scaled input vector;
scaling the collision avoidance velocity vector by a second scaling parameter to generate a scaled collision avoidance velocity vector; and
adding the scaled input vector to the scaled collision avoidance velocity vector.

94-123. (canceled)
